(19) United States
(12) Patent Application Publication
(10) Pub. No.: US 2003/0083923 A1
(43) Pub. Date: May 1, 2003

(54) Collaboration-enabled enterprise

(76) Inventors: Diego Guicciardi, Houston, TX (US); George P. Lucas, Missouri City, TX (US); Jean-Claude Hujeux, Houston, TX (US)

Correspondence Address: ROSENTHAL & OSHA L.L.P., 1221 MCKINNEY AVENUE, SUITE 2800, HOUSTON, TX, 77010, US

(21) Appl. No.: 10/281,870

(22) Filed: Oct. 28, 2002

Related U.S. Application Data
(60) Provisional application No. 60/350,472, filed on Oct. 29, 2001.

(51) Int. Cl. G06F 17/60

(52) U.S. Cl. 705/9

(57) ABSTRACT

A method of enabling an enterprise for collaboration includes evaluating the enterprise for collaborative potential, selecting a first process of the enterprise using a first result of the evaluation of the enterprise, generating a first Collaboration-Enabled Process (CEP) using the first process if the first process satisfies a first criteria, generating a first Virtual Collaborative Community (VCC) using a first plurality of employees of the enterprise, and executing the first CEP using the VCC, wherein a first member and a second member of the first plurality of employees collaborate in executing the first CEP by communicating via a first virtual hub.

### CROSS-REFERENCE TO RELATED APPLICATIONS

This patent application claims benefit of provisional patent application No. 60/350,472 entitled “Collaboration-Enabled Enterprise” and filed on Oct. 29, 2001.

### BACKGROUND OF THE INVENTION

Procedures used by enterprises to accomplish organizational goals, such as whatever techniques and/or steps are used by a network solutions provider to install a computer network, are known as processes. A process is a set of business activities that transform a set of inputs into a set of outputs (inputs and outputs typically being goods or services). FIG. 1 shows entities associated with a process (10). Inputs (12) to the process (10) come from a first entity such as a supplier (14). Outputs (16) go to a second entity, such as a customer (18). A process is generally intended to accomplish some desired outcome or result, i.e., a goal, such as increasing sales.

For example, an enterprise may hire a VPN rollout team, which includes one or more technical consultants, to design and install a Virtual Private Network (VPN) in order to better serve its clientele. Typically, the enterprise already has in place a set of processes that help the enterprise accomplish its goals. For example, the enterprise may have processes to guide employees in everyday activities, such as an instruction sheet telling employees how to send a fax, or online help files telling employees how to arrange a videoconference, etc. In the course of designing and installing the VPN, the VPN rollout team may consider what changes need to be made to current processes in order to migrate the enterprise from whatever network systems are currently used, to the VPN. For example, the VPN rollout team may make modifications to existing processes (e.g., the VPN rollout team may include instructions for how to use the VPN in video conferencing situations). In the course of the VPN rollout, the VPN rollout team may also restructure the enterprise's organizational hierarchy in order to facilitate migration to the VPN.

Additionally, the VPN rollout team may be required to develop entirely new processes for the enterprise. Process development often uses certain well-known tools and analytical techniques, such as process development and modeling techniques and software, process workflow mappings, etc. A process workflow mapping describes sequential and/or concurrent workflow activities essential to a process. For example, a systems administrator for the enterprise may handle troubleshooting of network problems by following certain procedures. For example, the systems administrator may first check certain configuration files, then, secondly check for ping times, etc. Thus, such procedures form a process workflow.

The process workflow may be decomposed into multiple components, e.g., checking ping times. A particular component of the process workflow may be decomposed into subordinate components. For example, checking ping times may include a subordinate component of executing a particular shell script. The particular arrangement of the components of the process workflow (e.g., a particular chronological sequence of performing each component) is a process workflow. The components of the process workflow are executed by the employees, e.g., the system administrator checks configuration files and checks ping times.

Processes are often categorized as either procedural-based processes, or project-based processes. An example of a procedural-based process is the previous example of the trouble-shooting of network problems by the systems administrator. An example of a project-based process is the previous example of the VPN rollout.

Tools may be used to generate documentation related to process workflow, process modeling and development, etc. For example, a software package such as Teamflow™(a trademark of CFM, Inc.) to map process workflows. Another tool for modeling processes is a process definition notation, such as Entry Task Validation Exit (EVTX) notation. EVTX is often used among process development teams in order to model processes. FIG. 2 shows an ETVX process cell (30) for process development. An entry criteria checklist (32), which is a list of criteria satisfied before starting a process proper, is performed. Then, a task list (34) is performed (e.g., check certain configuration files, then, secondly check for ping times, etc.), and a validation/verification procedure (36) is performed for quality control purposes. Finally, an exit criteria checklist (38) is performed.

When a team of technical consultants is hired by a client enterprise to develop one or more new processes, the team may often follow a routine method of developing a potential new process. FIG. 3 shows a flow diagram for process development, such as may be used by the VPN rollout team. The VPN rollout team first analyzes the goals, needs, and resources of the client enterprise with respect to the potential new process (Step 40). Collateral information may be collected as part of Step 40. Collateral information is information helpful for process development. For example, the VPN rollout team may determine which employees are responsible for which components of the new process. Next, a new process workflow is developed that fits the goals, needs, and resources of the client enterprise (Step 42). Once the new process workflow is developed, support is provided for execution of the new process workflow (Step 44). For example, the VPN team may supply documentation for training, such as help files, process performance assessment tools, location of relevant reference knowledge, etc. The collateral information may be used in order to provide such support and documentation. Support may be critical for project-based processes, especially processes developed for use in a collaborative environment, such as for a client enterprise that has employees that need to interact using communication networks.

Then, the new process workflow is executed (i.e., the components of the new process workflow are executed), and an evaluation is made of the performance of the new process workflow (Step 46). Performance evaluation may involve both quantitative and qualitative input. For example, network downtimes may be measured as a metric of evaluating the performance of the new process workflow. Also, evaluation may be in the form of opinions from Subject Matter Experts (SME's).

Then, the new process workflow is modified as needed, based on the evaluation (Step 48). For example, certain components of the process workflow may be modified in order to achieved desired outcomes and goals; such modifications are often guided by quantified metrics, lessons learned during execution of the process workflow, and best practices developed by employees involved in process workflow execution.

The VPN rollout team may develop multiple new processes for the client enterprise using the flow diagram shown in FIG. 3, and when work is complete, collect a fee, and move on to another client enterprise, once again performing the method shown in FIG. 3. Often, new processes are developed for different clients in a de novo fashion, i.e., new processes for each new client are developed “from scratch.”

Recent rapid advances in technologies, such VPN's, has been a major factor in organizational change. Corporations are often required to adapt to changing technologies, market conditions, or other changes, in order to survive. However, although enterprises such as corporations may indeed need to change in order to survive, such change may not come easily. Corporations are social entities populated by their employees, and the employees may be resistant to change, or may find change difficult. For example, a certain employee may not be computer-literate, thus hindering adoption of a computer network, such as a VPN. Therefore, enterprises such as corporations sometimes hire Change Management (CM) consultants in order to implement and/or facilitate fundamental or important organizational change.

CM is a set of techniques and tools often used to bring about and facilitate organizational change. CM draws on multiple sciences and fields of endeavor. CM often uses ideas and techniques from psychology, sociology, business administration, economics, industrial engineering, etc. In the course of doing their jobs, CM consultants often use techniques such as employees interviews and may also administer questionnaires to employees. For example, in order to facilitate new processes at a factory, a CM consultant may interview the factory workers in order to assess their readiness for the new processes. Employees whom the CM consultants feel may not be ready for the new processes may be recommended for extra training.

CM consultants often consider more personal and even psychological aspects of organizational change. For example, a CM consultant, using such techniques as interview or questionnaires, may attempt to determine which employees are more or less receptive to an upcoming organizational change, or to change in general. CM consultants may also be used to determine which employees are potentially best at doing particular jobs. CM consultants may also design new organizational practices and processes in order to facilitate change. For example, in order to help usher in an upcoming organizational change, such as a new processes for installing a computer network, a CM consultant may design and institute and reward systems rewarding those who quickly adopt the new processes. More subtle and psychology-based reward systems may be used, such as praising such early adopters in a company newsletter, or publicizing a successful transition to a new computer network by a particular person or team of people.

In addition to facilitating change with respect to processes involved with new technology (such as with new computer networks), CM consultants may also be involved with cultural change within an enterprise. For example, corporate management may want employees to collaborate more with other employees. In order bring about such increased collaboration (and the rewards that such increased collaboration may bring), management may also install a new, high-powered computer network. However, a given enterprise may not have an organizational culture that promotes or accepts such increased collaboration. For example, a particular corporation may have a corporate culture that is highly competitive, which may hinder adoption of new technologies or more processes that use or require increases collaboration.

Furthermore, organizational changes that require technological change (e.g., a new computer network) may also require that management also address not only issues involving how to facilitate adoption of the new computer network by the employees, but also issues of how to adapt current business processes to such new technology. Although, for example, with the help of CM consultants, employees may adapt to a new computer network and a new organizational culture of collaboration, certain processes may require alteration or replacement in order to be executed collaboratively, especially when that collaborative execution takes place over a computer network. Other processes may not be suitable for collaboration at all, or the cost of such alteration may outweigh any possible gains.

### SUMMARY OF INVENTION

In general, in one aspect, the invention relates to a method of enabling an enterprise for collaboration. The method comprises evaluating the enterprise for collaborative potential, selecting a first process of the enterprise using a first result of the evaluation of the enterprise, generating a first Collaboration-Enabled Process (CEP) using the first process if the first process satisfies a first criteria, generating a first Virtual Collaborative Community (VCC) using a first plurality of employees of the enterprise, and executing the first CEP using the VCC, wherein a first member and a second member of the first plurality of employees collaborate in executing the first CEP by communicating via a first virtual hub.

In general, in one aspect, the invention relates to a method of enabling an enterprise for collaboration. The method comprises evaluating the enterprise for collaborative potential, selecting a first process of the enterprise using a first result of the evaluation of the enterprise, generating a first Collaboration-Enabled Process (CEP) using the first process if the first process satisfies a first criteria, generating a first Virtual Collaborative Community (VCC) using a first plurality of employees of the enterprise, executing the first CEP using the VCC, wherein a first member and a second member of the first plurality of employees collaborate in executing the first CEP by communicating via a first virtual hub, obtaining content for the first VCC using a second result of the evaluation, organizing the content and making the content available to entities outside the first VCC via a technology framework and the first virtual hub, selecting a second process of the enterprise using a second result of the evaluation, generating a second CEP using the second process if the second process satisfies a second criteria, generating a second VCC using a second plurality of employees of the enterprise, executing the second CEP using the second plurality of employees, wherein a third member and a fourth member of the second plurality of employees collaborate in executing the second CEP by communicating via a second virtual hub, obtaining knowledge learned from the execution of the first CEP, adding the knowledge to the content and using the knowledge to modify the first CEP, obtaining the content by the third member of the second plurality of employees via the technology framework and the first virtual hub, using the content to modify the second CEP, and generating a reward system, wherein the reward system rewards a member of the first plurality of employees for collaborative behavior.

In general, in one aspect, the invention relates to a Collaboration-Enabled Enterprise (CEE). The Collaboration-Enabled Enterprise (CEE) comprises a first Collaboration-Enabled Process (CEP), supporting an output of the CEE, collaboratively executed by a plurality of members of a first Virtual Collaborative Community (VCC) via a virtual hub, a Synergy people framework supporting the virtual hub, configured to facilitate collaboration between the plurality of members of the first VCC, and a second VCC, configured to obtain content of the first VCC via a Synergy technology framework and the virtual hub and modify a second CEP using the content.

In general, in one aspect, the invention relates to a method of converting a process to a Collaboration-Enabled Process (CEP) using a Collaborative-Process Development Process (C-PDP). The method comprises conducting a first analysis of the workflow of the process, conducting a second analysis of available resources for executing the process, selecting a collaborative enhancement for the process, and generating a modified workflow of the process by adding collaboration instructions to the workflow.

In general, in one aspect, the invention relates to a method of converting a process to a Collaboration-Enabled Process (CEP) using a Collaborative-Process Development Process (C-PDP). The method comprises conducting a first analysis of the workflow of the process, conducting a second analysis of available resources for executing the process, selecting a collaborative enhancement for the process, and generating a modified workflow of the process by adding collaboration instructions to the workflow.

In general, in one aspect, the invention relates to an apparatus for enabling an enterprise for collaboration. The apparatus comprises means for evaluating the enterprise for collaborative potential, means for selecting a first process of the enterprise using a first result of the evaluation of the enterprise, means for generating a first Collaboration-Enabled Process (CEP) using the first process if the first process satisfies a first criteria, means for generating a first Virtual Collaborative Community (VCC) using a first plurality of employees of the enterprise, and means for executing the first CEP using the VCC, wherein a first member and a second member of the first plurality of employees collaborate in executing the first CEP by communicating via a first virtual hub.

In general, in one aspect, the invention relates to an apparatus for converting a process to a Collaboration-Enabled Process (CEP) means for using a Collaborative-Process Development Process (C-PDP). The apparatus comprises means for conducting a first analysis of the workflow of the process, means for conducting a second analysis of available resources for executing the process, means for selecting a collaborative enhancement for the process, and means for generating a modified workflow of the process by adding collaboration instructions to the workflow.

Other aspects and advantages of the invention will be apparent from the following description and the appended claims.

### BRIEF DESCRIPTION OF DRAWINGS

FIG. 1 shows entities associated with a process.

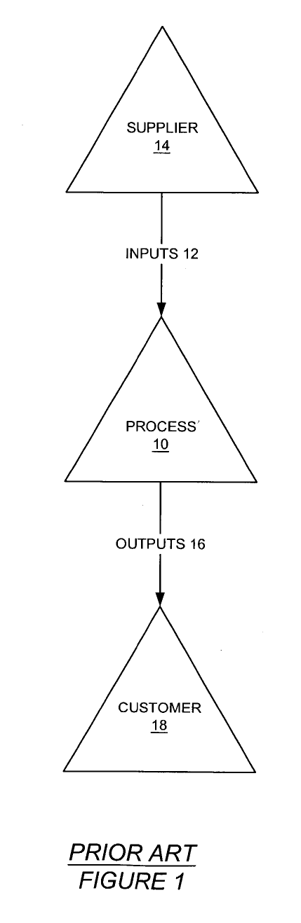

FIG. 2 shows an ETVX process cell for process development.

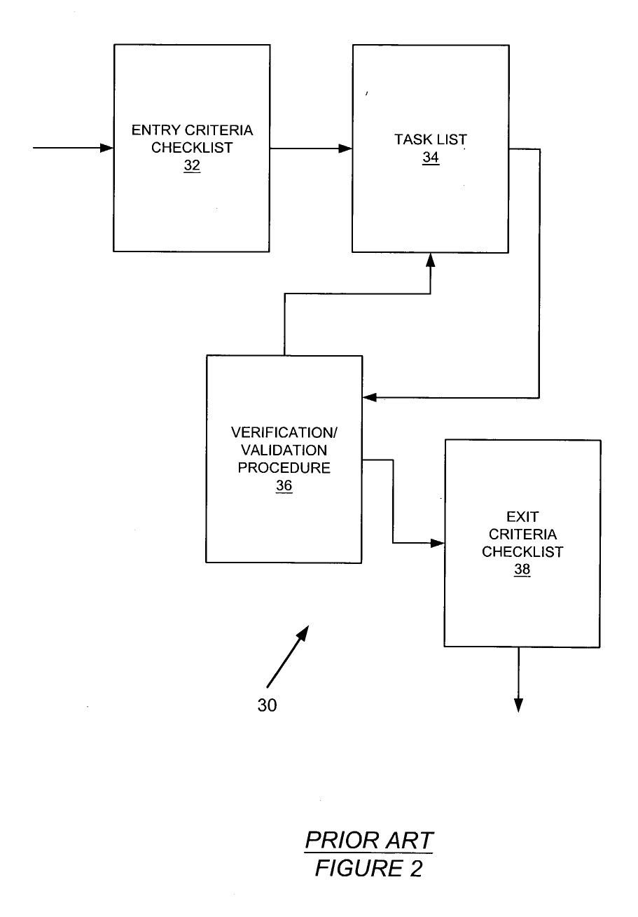

FIG. 3 shows a flow diagram for process development.

FIG. 4 shows a typical networked computer system.

FIG. 5 shows entities involved with an embodiment of the invention.

FIG. 6 shows a Synergy framework, in accordance with an embodiment of the invention.

FIG. 7 shows a secured version of a Synergy Technology framework, in accordance with an embodiment of the invention.

FIG. 8 shows a solutions virtual hub, in accordance with an embodiment of the invention.

FIG. 9 shows a taxonomy diagram for Solutions Technologies Methodologies (STM)/Products Technologies Methodologies (PTM) virtual hubs, in accordance with an embodiment of the invention.

FIG. 10 shows an exemplary implementation of the solutions virtual hub, in accordance with an embodiment of the invention.

FIG. 11 shows components of a Synergy people framework collaborating using a virtual hub, in accordance with an embodiment of the invention.

FIG. 12 shows a flow diagram of a Process Development Process (PDP) workflow for developing a process, in accordance with an embodiment of the invention.

FIG. 13 shows a first Graphical User Interface (GUI) representing a flow diagram that shows top-level components of a PDP workflow, in accordance with an embodiment of the invention.

FIG. 14 shows a second GUI with icons representing multiple PDP workflow components, in accordance with an embodiment of the invention.

FIG. 15 shows an exemplary Process Configuration Form, in accordance with an embodiment of the invention.

FIG. 16 shows a third GUI that shows icons representing lower-level PDP workflow components, in accordance with an embodiment of the invention.

FIG. 17 shows a PDP template, in accordance with an embodiment of the invention.

FIG. 18 shows a sequence of operations for a Collaborative Process Development Process (C-PDP) workflow, in accordance with an embodiment of the invention.

FIG. 19 shows a sequence of four phases for converting a particular enterprise to a Collaboration-Enabled Enterprise (CEE), in accordance with an embodiment of the invention.

FIG. 20 shows a first portion of a flow diagram for converting a particular enterprise to a CEE, in accordance with an embodiment of the invention.

FIG. 21 shows a second portion of a flow diagram for converting a particular enterprise to CEE, in accordance with an embodiment of the invention.

FIG. 22 shows a third portion of a flow diagram for converting a particular enterprise to CEE, in accordance with an embodiment of the invention.

FIG. 23 shows a fourth portion of a flow diagram for converting a particular enterprise to CEE, in accordance with an embodiment of the invention.

FIG. 24 shows a fifth portion of a flow diagram for converting a particular enterprise to CEE, in accordance with an embodiment of the invention.

FIG. 25 shows a sixth portion of a flow diagram for converting a particular enterprise to CEE, in accordance with an embodiment of the invention.

FIG. 26 shows a seventh portion of a flow diagram for converting a particular enterprise to CEE, in accordance with an embodiment of the invention.

### DETAILED DESCRIPTION

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

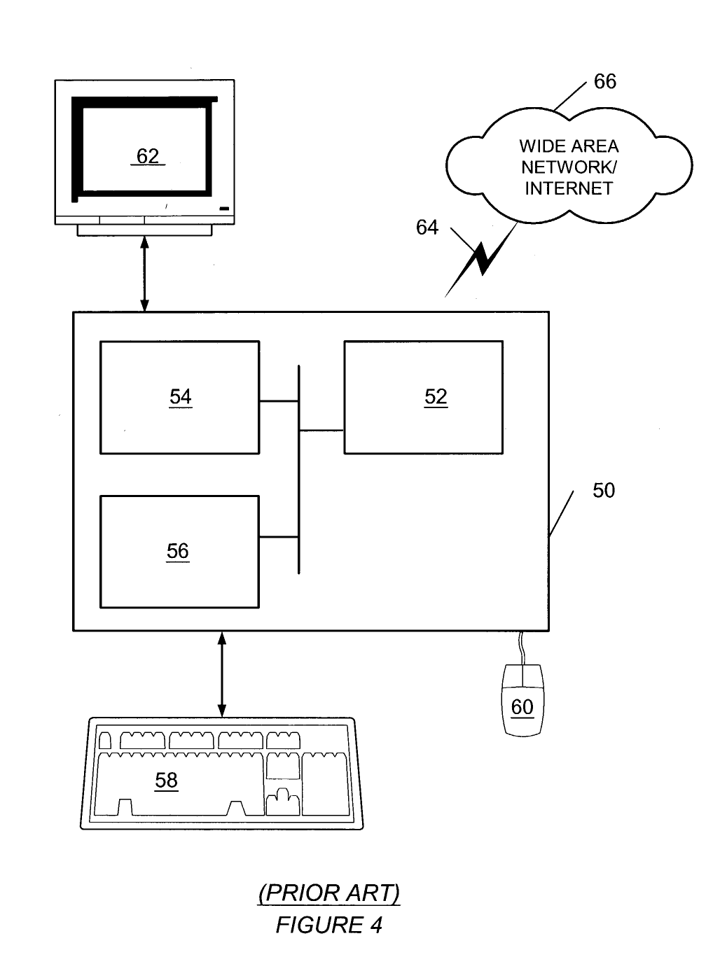

Aspects of the invention may be implemented on virtually any type computer regardless of the platform being used. For example, as shown in FIG. 4, a typical computer (50) includes a processor (52), an associated memory (54), a storage device (56), and numerous other elements and functionalities typical of today's computers (not shown). The computer (50) may also include input means, such as a keyboard (58) and a mouse (60), and an output device, such as a monitor (62). Those skilled in the art will appreciate that these input and output means may take other forms in an accessible environment. The computer (50) may be connected via a network connection (64) to a Wide Area Network (WAN) (66), such as the Internet.

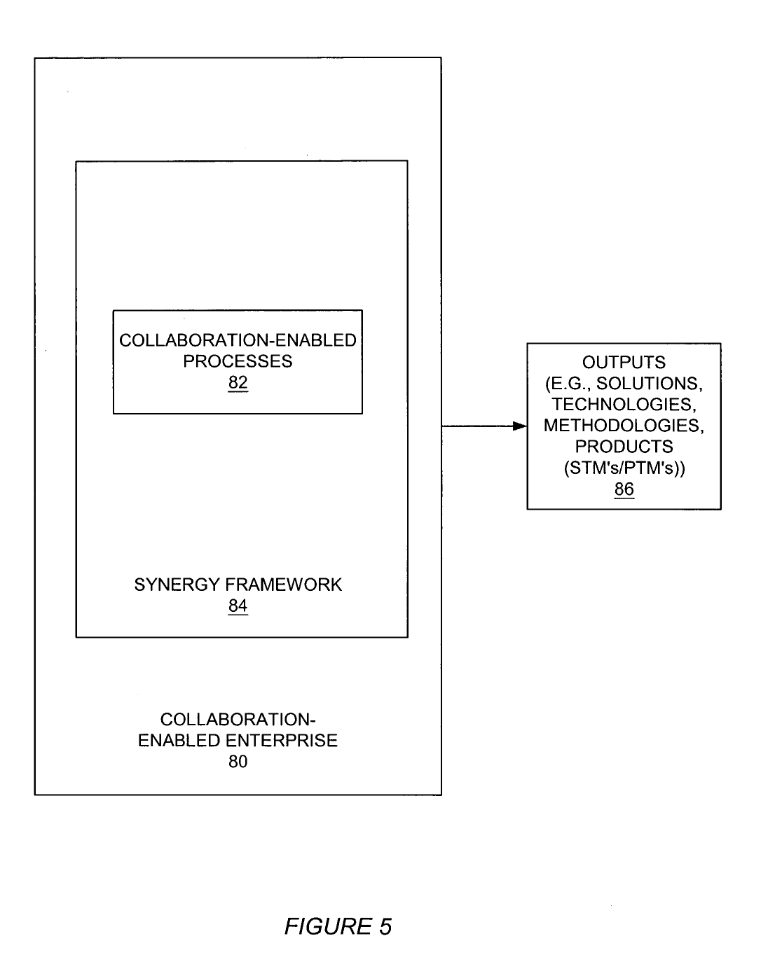

The invention, in one or more aspects, involves converting enterprises to collaboration-enabled enterprises by providing collaborative processes and the necessary technological and personnel frameworks needed to support execution of the collaborative processes. Entities involved in an embodiment of the present invention are shown in FIG. 5. A Collaboration-Enabled Enterprise (CEE) (80) includes one or more Collaboration-Enabled Processes (CEP's) (82) executing within a Synergy framework (84) to produce one or more outputs (86). The outputs (86) may be Solutions, Technologies, and Methodologies (STM's). For example, a particular CEE may have provide to clients technology solutions, such as network installations, and the CEE may use certain Technologies (e.g., computers), and Methodologies, such as network troubleshooting process order to provide network installation services to clients. For CEE's that produce products (i.e., widgets), Solutions, Technologies, and Methodologies are replaced by Products, Technologies, and Methodologies (PTM's). The CEP's (82) executing within the Synergy framework (84) support the STM's or PTM's.

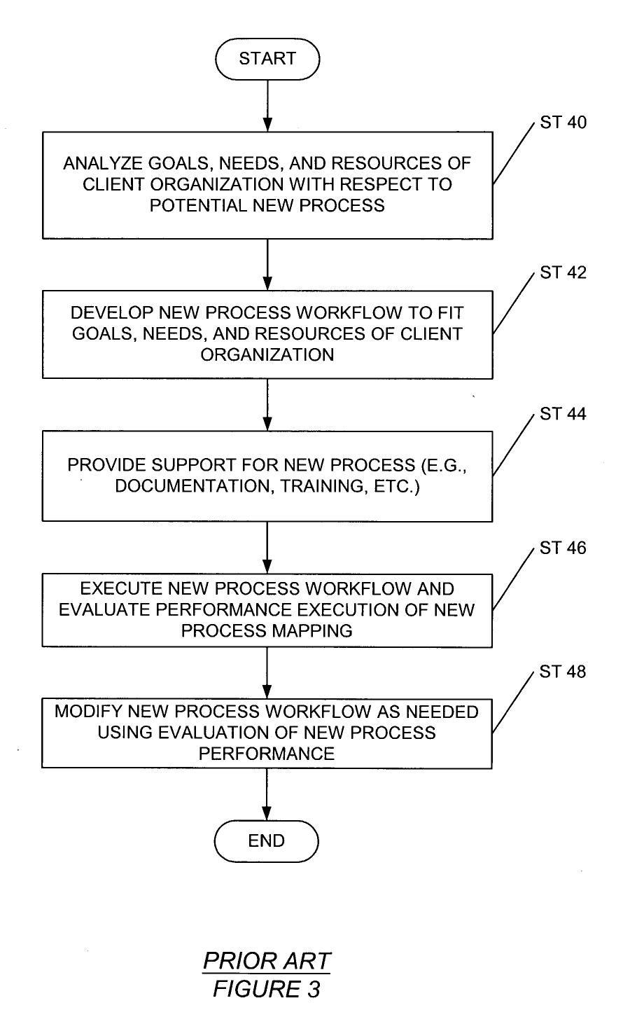

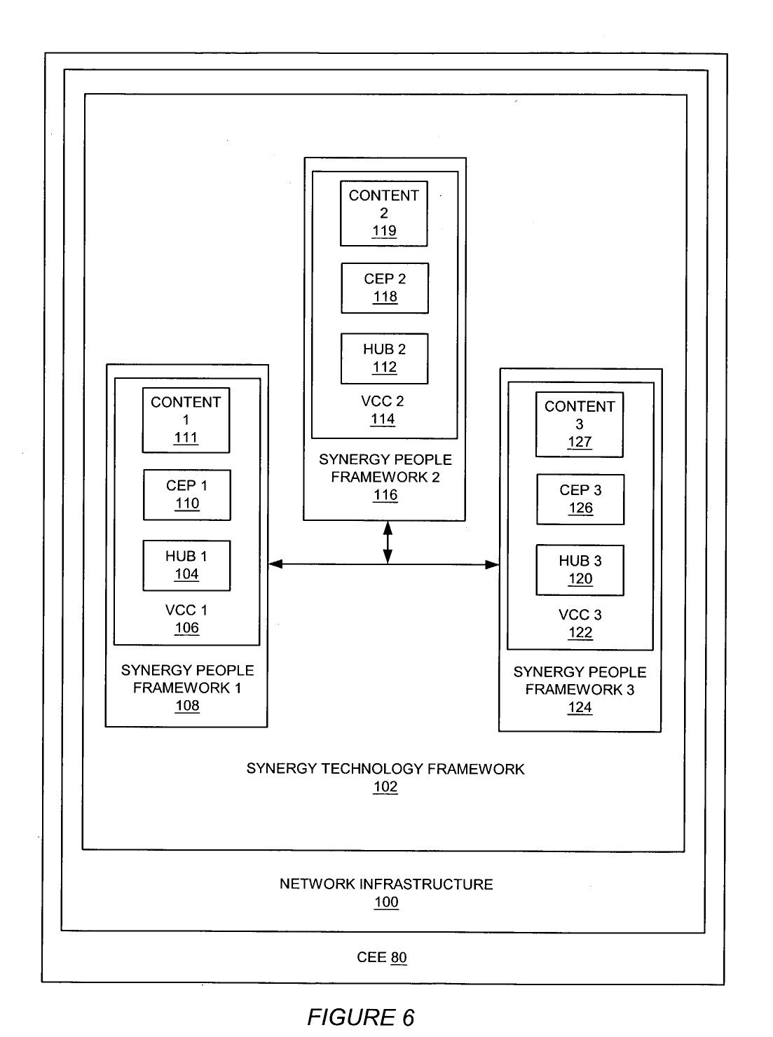

The Synergy framework (84) is a set of frameworks, as shown in FIG. 6. A network infrastructure (100) is specifically enabled to handle digital communications traffic inherent in a collaborative environment in which the CEE (80) operates. The Synergy framework (84 in FIG. 3) also includes a Synergy Technology framework (102), which is a set of applications within which the CEE (80) operates. A Synergy Virtual Hub 1 (104) provides communications for collaboration for members of a Virtual Collaborative Community (VCC) 1 (106).

A Synergy People framework 1 (108) supports the VCC 1 (106). People (e.g., employees, contractors, etc., of the CEE (80)) of the VCC 1 (106) and the Synergy People framework 1 (108) collaborate to support the VCC 1 (106) and to execute a set of CEP's, for example, CEP 1 (110). The Synergy Virtual Hub 1 (104) enables exchanges of knowledge from a Content 1 (111) among the VCC 1 (106) in order to support an STM or PTM. Synergy Virtual Hub 2 (112), VCC 2 (114), Synergy People framework 2 (116), CEP 2 (118), and Content 2 (119) function similarly, as do Synergy Virtual Hub 3 (120), VCC 3(122), Synergy People framework 3 (124), CEP 3 (126), and VCC 3 (127). Also, the Synergy Technology framework supports exchange of content (from Content 1 (111), Content 2 (119), and Content 3 (127) among the VCC 1 (106), VCC 2 (114), and VCC 3 (122).

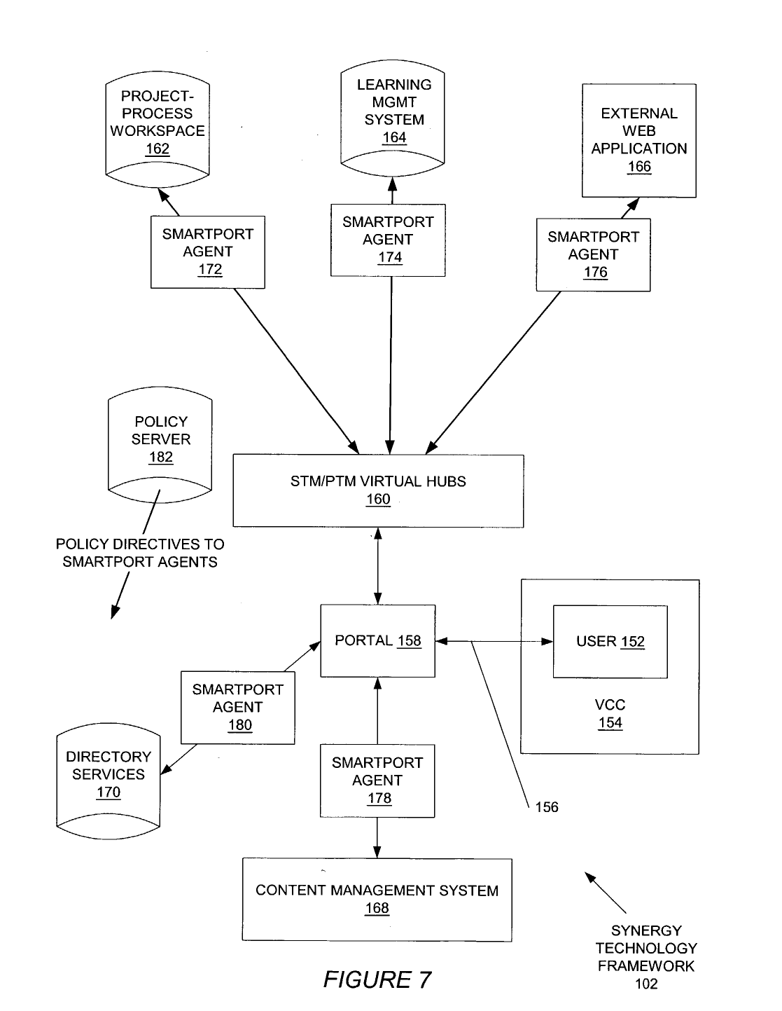

In accordance with one or more embodiments of the invention, a secured version of the Synergy Technology framework (102) is shown in FIG. 7. A user (152) in a VCC (154) has a secure (i.e., encrypted) connection to a portal (158). The user (152) is connected via the portal (158) to one or more Virtual Hubs (160), which are STM virtual hubs, i.e., virtual hubs for STM's and/or PTM's. The Virtual Hubs (160) exchange knowledge with components of the Synergy Technology framework (102), such as a project process workspace (162), which enhances collaboration for project-based activities. Other components include the learning management system (164) and external web applications (166), which may include applications such as Enterprise Resource Planning (ERP) applications, Customer Relationship Management (CRM), etc. Knowledge exchanges between the Virtual Hubs (160) and components such as the learning management system (164) are, in accordance with one or more embodiments of the invention, implemented using hyperlinks. In accordance with one or more embodiments of the invention, the Virtual Hubs (160) are supported by a Hub Desk with helpdesk capability.

The portal is connected to a content management system (168) and a directory services (170). In accordance with one or more embodiments of the invention, the directory services (170) is a Lightweight Directory Access Protocol (LDAP)-compliant directory server for authentication and authorization. The content management system (178) contains shared knowledge for exchange using the portal (158).

A security management system includes smartport agents (172), (174), (176), (178), and (180). The security management system secures communications of the Synergy Technology framework (102). The security management system, which also includes smart card security tokens managed within a Public Key Infrastructure (PKI). The smart card security tokens include private keys of users, e.g., the user (152). A policy server (182) includes policy directives to the Synergy Technology framework (102) applications, e.g., to the smartport agents (172, 174, 176, 178, and 180). The smartport agents (172, 174, 176, 178, and 180) intercept traffic into a server of the Synergy technology framework and verify an access privilege of the user (152) via the policy server (182).

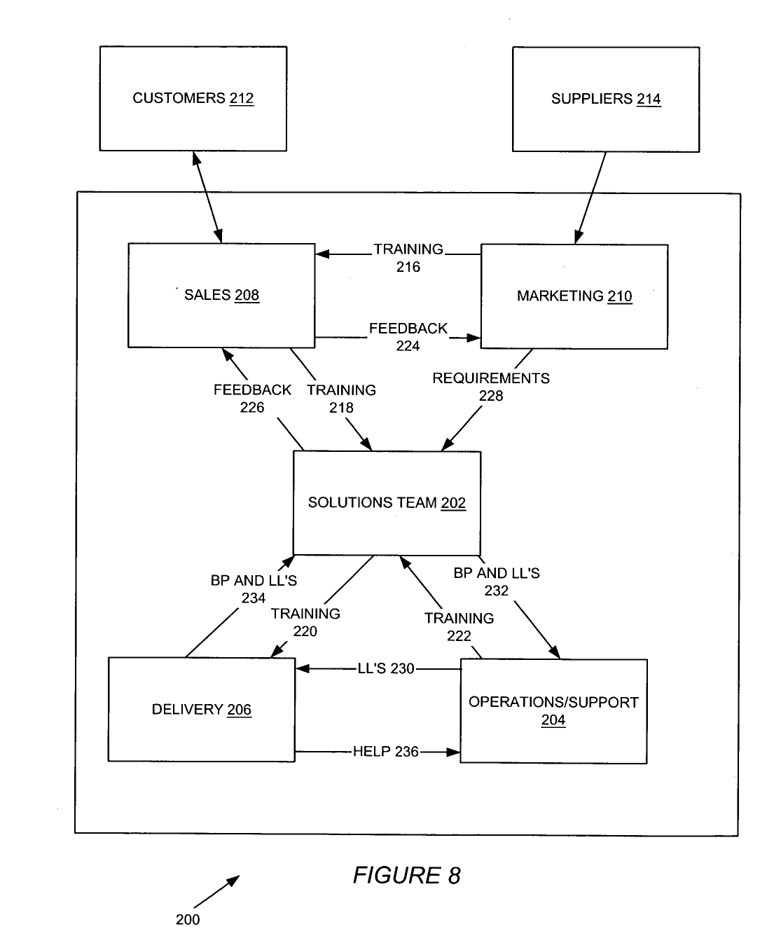

Each VCC and the VCC's corresponding Virtual Hub support a particular output (i.e., a particular Solution, Technology, or Methodology). Each virtual hub is designed for the particular VCC the virtual hub supports. FIG. 8 shows a solutions virtual hub (200) supporting components of a Solutions VCC. Components of the Solutions VCC include a Solutions team (202), which is a knowledge gatekeeper. Other components of the Solutions VCC include operations/support personnel (204), delivery personnel (206), a sales team (208), marketing team (210), customers (212), and suppliers (214). Knowledge exchanges between components of the Solutions VCC include training (216), (218), (220), and (222), feedback (224) and (226), requirements (228), Lessons Learned (LL) (230), Best Practices (BP) and Lessons Learned (LL) (232) and (234), and help (236).

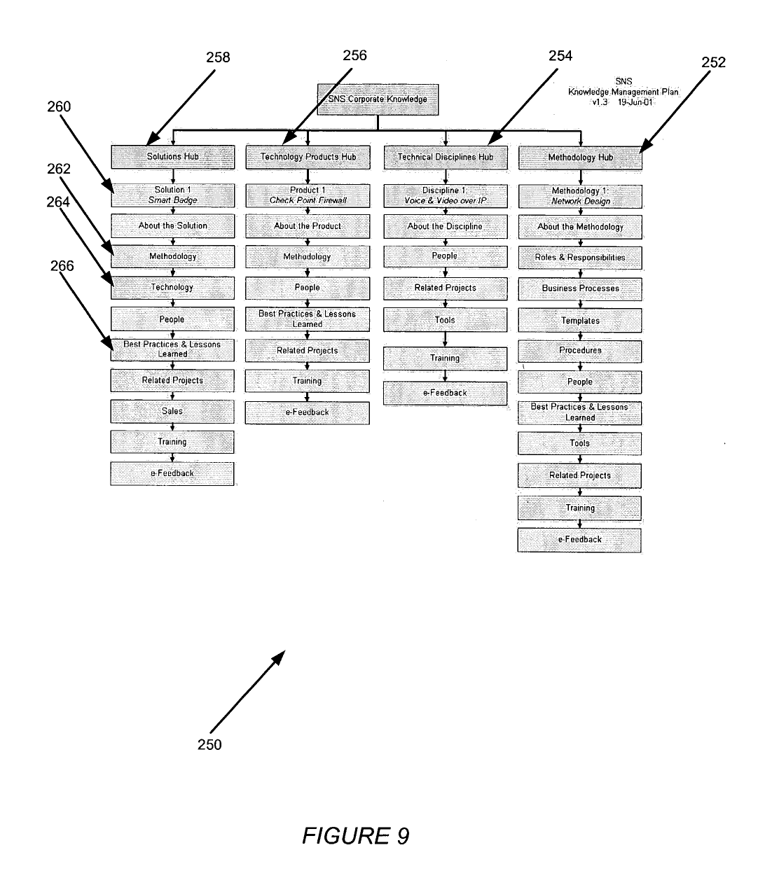

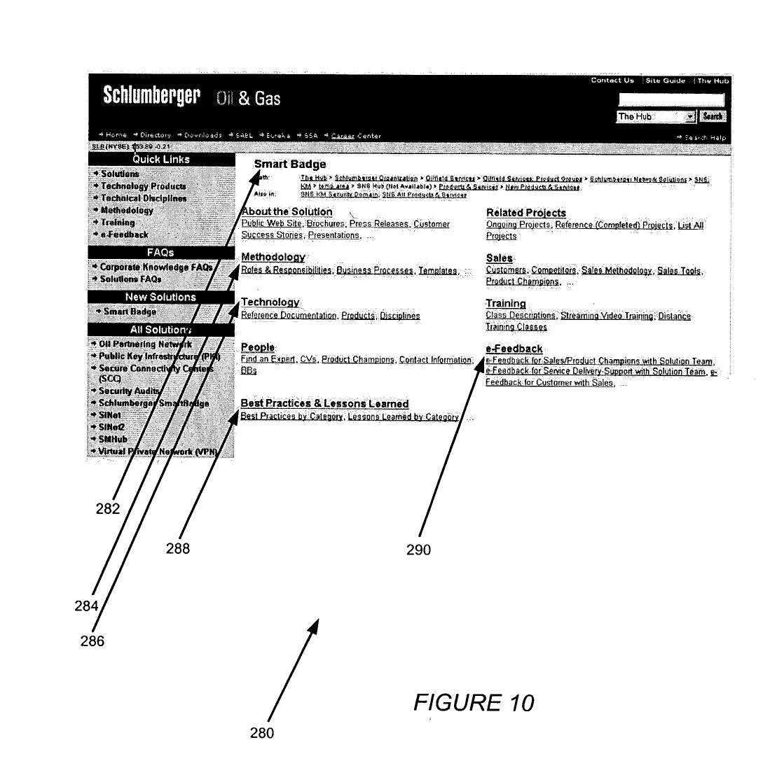

Knowledge and content accessible from a VCC via a Virtual hub and the Synergy Technology framework may be organized using a taxonomy. FIG. 9 shows a taxonomy diagram (250) for STM/PTM virtual hubs. A methodology virtual hub (252), a technical disciplines virtual hub (254), a technology products virtual hub (256), and a solutions virtual hub (258) each have components. For example, the solutions virtual hub (258) has a solution 1 Smart Badge component (260), a methodology component (262), a technology component (264), and a best practices and lessons learned component (266). An exemplary implementation of the solutions virtual hub (258) is shown in FIG. 10. A web page solutions virtual hub (290) includes hyperlinks that represent the components of the solutions virtual hub (258 in FIG. 9) from the taxonomy diagram (250 in FIG. 9). For example, a Smart Badge hyperlink (282) represents the Smart Badge component (260 in FIG. 9), a methodology hyperlink (284) represents the methodology component (262 in FIG. 9), a technology hyperlink (286) represents the technology component (284 in FIG. 9), and a best practices and lessons learned hyperlink (288) represents the best practices and lessons learned component (266 in FIG. 9).

Collaboration in VCC's using virtual hubs occurs through both people-to-information (p2i) collaboration components and people-to-people collaboration (p2p) components. For example, referring to FIG. 10, an e-Feedback hyperlink (290) represents a p2p collaboration component. The technology hyperlink (286) represents a p2p collaboration component.

Collaboration in VCC's occurs through both knowledge providers and knowledge consumers of the Synergy people framework. Knowledge providers may be full-time, or part-time. The knowledge providers are knowledge gatekeepers and may be located anywhere in an enterprise at any hierarchical level. Part-time knowledge providers may be referred to as “T-shaped,” extending the concept of the “T-shaped Manager,” attributed to Harvard Business School, where “T-shaped” refers to a manager that does more than one job by both sharing across the manager's own department and sharing knowledge across the manager's entire enterprise [see “Introducing T-Shaped Managers: Knowledge Management's next Generation” by Morten T. Hansen and Bolko von Oetinger]. Thus, when using the Synergy frameworks, the enterprise is a T-shaped enterprise.

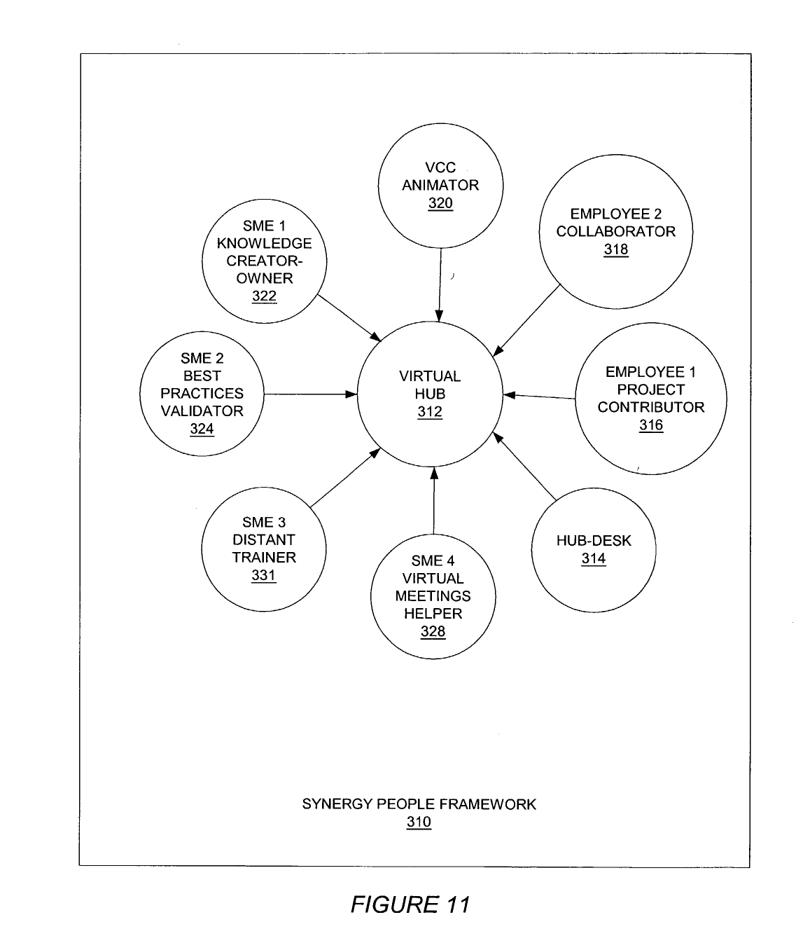

FIG. 11 shows components of a Synergy people framework (310) collaborating using a virtual hub (312). Some or all of the people operating within the Synergy people framework (310) may be T-shaped. Components of the Synergy people framework (310) include a hub-desk (314) for supporting primary knowledge stores. Also included are an employee 1 (316), a project contributor, who contributes with projects, Best Practices (BP's) and Lesson Learned (LL's), and an employee 2 (318), a collaborator, who collaborates according to CEP's. A VCC animator (320) facilitates operation of the VCC that uses the virtual hub (312). A Subject Matter Expert (SME) 1 (322) is a knowledge creator-owner. An SME 2 (324) is a best practices validator. An SME 3 (326) is a distant trainer. An SME 4 (328) is a virtual meetings helper.

A CEP is generated by adding collaborative enhancements to a process. A Process Development Process (PDP) workflow and a PDP toolkit is used to develop a process, and a Collaborative Process Development Process (C-PDP), which uses PDP as a core process, adds collaborative enhancements in order to transform processes to CEP's.

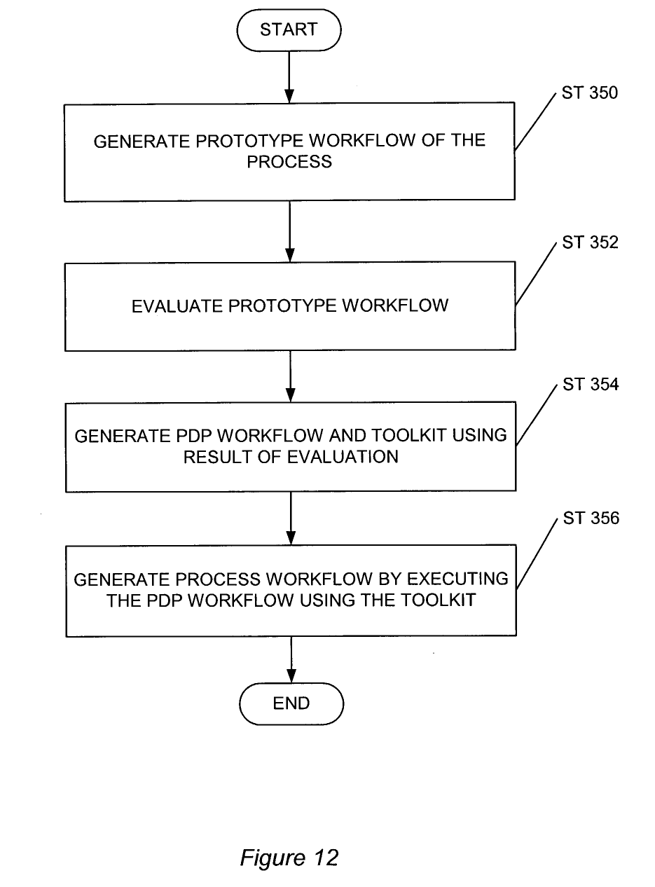

The PDP workflow and the PDP toolkit facilitate development of processes in a manner intended to address issues of quality and efficiency, and provides a solid structural framework for development of a process. A flow diagram of a Process Development Process (PDP) workflow for developing a process is shown in FIG. 12. First, a prototype workflow of the process is generated (Step 350). The prototype workflow may entail, in accordance with one or more embodiments of the invention, developing the process “from scratch.” The process may be a project-based process, such as a process for rolling out a VPN, or a procedural-based process, such as a process for troubleshooting a network.

Once the prototype workflow is generated, the prototype workflow is evaluated (Step 352). Evaluating the prototype workflow includes determining what actions are required in order to generate the prototype workflow, and what collateral information is pertinent. Evaluating the prototype workflow may also include executing the prototype workflow in order to evaluate performance and effectiveness of the prototype workflow. Metrics information may also be obtained in order to evaluate the prototype workflow. For example, one or more pertinent parameters may be measured in order to evaluate performance of the prototype workflow. For example, if the process deals with networks, then network downtime may be measured.

Collateral information includes any information deemed useful in developing the prototype workflow and enhancing performance and quality of the prototype workflow. Collateral information may be information shown to be useful in light of experience. For example, after executing and evaluating the prototype workflow, a particular lesson learned may be used to form a best practice for future execution.

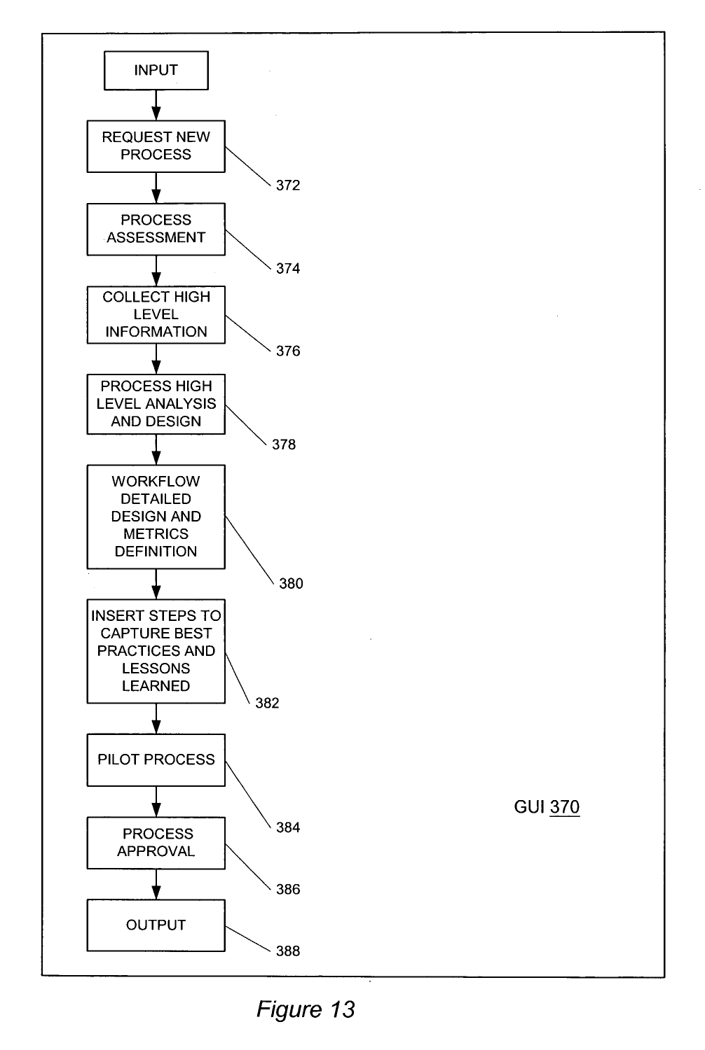

Once the prototype workflow has been evaluated, the PDP workflow and the PDP toolkit are generated using a result of the evaluation (Step 354). The PDP workflow is a top-down methodology for guiding a user or multiple users through development of a process workflow. The PDP toolkit includes, among other items, a graphical representation of components of the PDP workflow. FIG. 13 shows a GUI (370) representing a flow diagram that shows top-level components of the PDP workflow. The top-level components of the PDP workflow are modeling using Teamflow™. However, those skilled in the art will appreciate that other similar modeling tools may be used.

A first component of the PDP workflow involves requesting a new process (Step 372). For example, a client may require that a new process be developed in order to facilitate a VPN rollout. Often, development of new processes, in accordance with one or more embodiments of the invention, occurs as part of a process development project. Such a process development project may be implemented, in accordance with one or more embodiments of the invention, in a networked, collaborative workspace that involves multiple project members working together using collaboration software, such as Project.Net™.

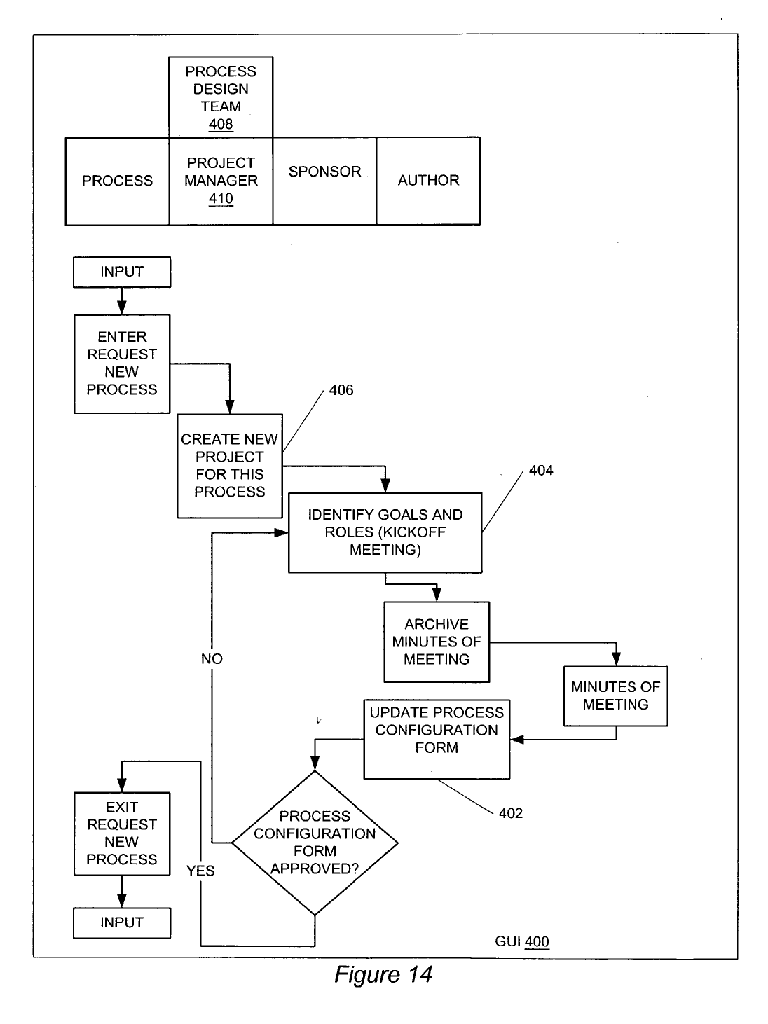

The first component of the PDP workflow, represented by an icon labeled “Request new process” (Step 372) is a top-level representation of multiple workflow components, each of which exist at lower hierarchy levels, and which are, in turn, shown on other GUI's that represent flow diagrams representing subordinate, lower-level PDP workflow components. For example, FIG. 14 shows a GUI (400) with icons representing multiple PDP workflow components, which may represent suggested tasks, such as “Update Process Configuration Form” (402).

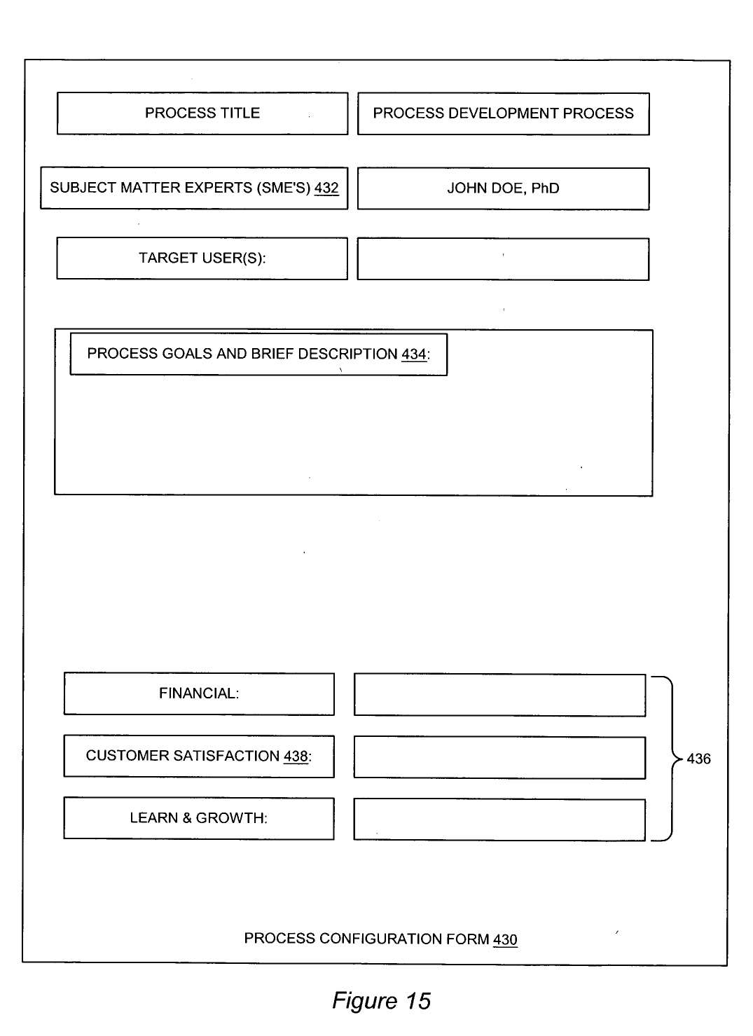

FIG. 15 shows an exemplary Process Configuration Form (430). The Process Configuration Form (430) is included as part of the PDP toolkit, and is used to organize and present information vital to development of the process, such as SME's involved in development of the process (432), a listing of goals and a description of the process being developed (434), a grouping of metrics parameters (436), such as customer satisfaction (438). Information associated with the Process Configuration Form (430) is typically both static and dynamic in nature, and describes characteristics of the process workflow in development. Parts of the Process Configuration Form (430) are updated regularly during development of the process, and as such, the Process Configuration Form (430) may be used to record and monitor completion status of process development.

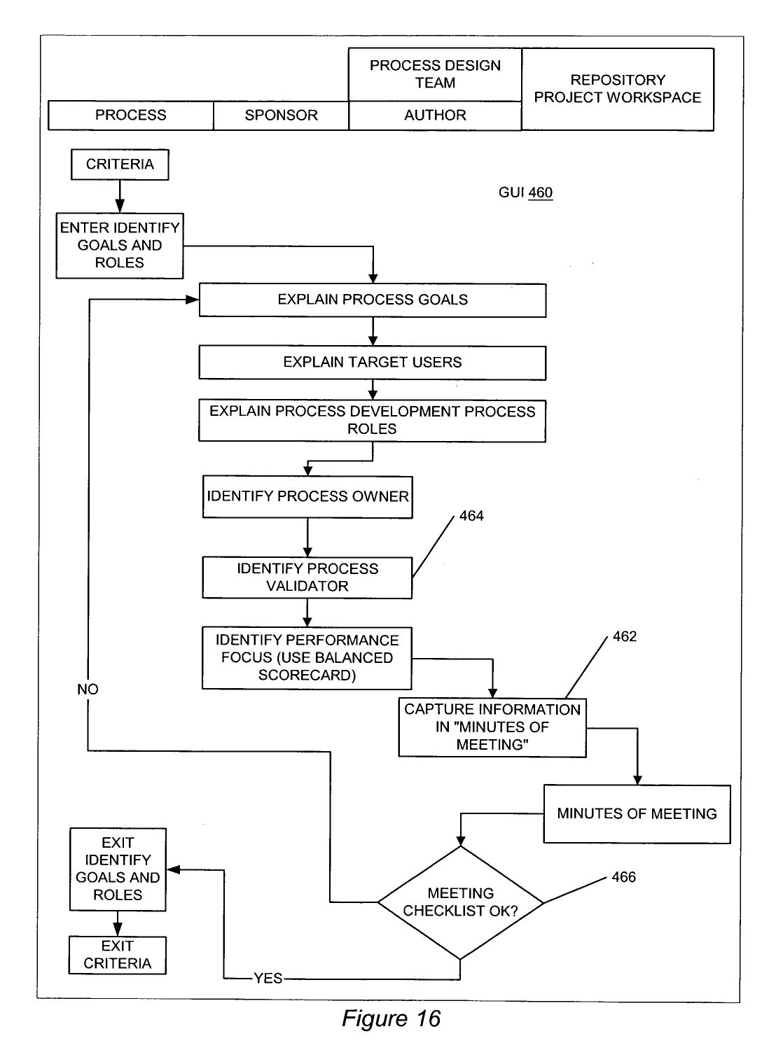

Returning to FIG. 14, an icon labeled “Identify Goals & Roles (Kickoff meeting)” (404) represents a PDP workflow component, which represents multiple lower-level workflow components, which are shown in FIG. 16, which shows a GUI (460) that shows icons representing lower-level PDP workflow components, such as an icon labeled “Capture information in the ‘Minutes of Meeting”’ (462). Information captured in meeting minutes may be included in collateral information, which is used to provide documentation to support execution of the process by the client organization. Other workflow components may suggest tasks to be performed, such as assigning roles and responsibilities for people involved in developing, supporting, and executing the process, such as represented by an icon labeled “Identify Process Validator” (464). An example of task verification, as embodied by ETVX principles, is represented by an icon labeled “Meeting Checklist OK?” (466).

Returning to FIG. 14, graphical linkage of roles and responsibilities for people involved in development of the process is shown by positional location of icons that represent PDP workflow components shown on the GUI (400). For example, an icon labeled “Create a new project for this process” (406) is the responsibility of a process design team and a project manager, as represented by icons labeled “Process Design Team” (408) and “Project Manager” (410), respectively.

Returning to FIG. 13, once the process is requested, the requested process is assessed (Step 374). Similar to the new process request PDP workflow component shown in Step 372, the process assessment PDP workflow component (Step 374) also represents multiple lower-level PDP workflow components, which are also represented by icons, which may be shown on GUI's implemented in Teamflow™. Although the lower-level PDP workflow components are not shown herein, lower-level PDP workflow components represented by Step 374 (and each other step shown in FIG. 13), like Step 372, also model the PDP workflow, suggest tasks, verify tasks, collect collateral information in both quantitative and qualitative forms. For example, the user may be presented with a questionnaire using a GUI (included as part of the PDP toolkit) that includes questions relating to desired goals of the process.

After process assessment, high level information associated with the requested process is collected (Step 376). Lower-level PDP workflow components for Step 376, although not shown herein, are represented by GUI icons. The high level information relates to gathering collateral information regarding roles and responsibilities of people involved in developing, supporting, and executing the process. High-level information may also include location of possible collateral knowledge, such as relevant reference knowledge, such as previously developed processes that may be recycled. Collateral information related to needed personnel training is also collected, which may be included in documentation for training to support execution of the process.

Next, process high level analysis and design associated with the process is performed (Step 378). Lower-level PDP workflow components for Step 378, although not shown herein, are represented by GUI icons. Process high level analysis and design involves decomposing components of the process into subordinate components. The PDP workflow may be divided into parallel phases, which are implemented concurrently as sub-processes. Roles and responsibilities are also assigned appropriately. For example, SME's will be assigned to particular components of a phase. Sources of relevant information are also identified. Also, task verification for particular PDP workflow components is accomplished.

Once process high level analysis and design is accomplished, then, workflow detailed design and metrics definition associated with the requested process is performed (Step 380). Lower-level PDP workflow components for Step 380, although not shown herein, are represented by GUI icons. Workflow detailed design involves preparing a draft workflow for components and subordinate components, discussing and clarifying goals, further identifying roles and responsibilities, and locating relevant reference knowledge.

Workflows are also validated in Step 380. Validation of workflows may be implemented using ETVX modeling and applied standards. For example, assigned roles and sequencing of workflows is checked. Also accomplished in Step 380 is identification of metrics information sources for workflows. Information identified as sources of metrics information includes information that measures whether the process has been successfully executed and/or achieves particular goals.

Once workflow detailed design and metrics definition is accomplished, steps are inserted into the process workflow in order to capture best practices and lessons learned during execution of the process workflow (once the process workflow has been generated and executed) (Step 382). For example, a relevant knowledge source captured through a questionnaire may reveal that before a particular workflow component of the process is executed, backup copies of computer data should be made.

Once steps are inserted to capture best practices and lessons learned, potential pilot processes or sub-processes are identified and implemented (Step 384). For example, the process under development may include multiple sub-processes, one or more of which are more likely to be successfully implemented than other sub-processes, thus being likely candidates for pilot processes. Identifying a potential pilot process may be accomplished through analysis of information gathered from people such as SME's using parts of the PDP toolkit, such as interactive GUI's.

A final top-level component of the PDP workflow is process approval (Step 386). Lower-level PDP workflow components for Step 386, although not shown herein, are represented by GUI icons. Step 386 involves validation each workflow component of the process under development for adherence to established standards. If a particular component of the process is not validated, the component is fixed.

An output of the PDP (388) includes a process workflow, e.g., a process for rolling out a VPN, or for troubleshooting a network. The output of the PDP (388) also includes the collateral knowledge, as gathered using PDP toolkit mechanisms, such as GUI questionnaires, etc., which is used to generate parts of the PDP toolkit. The PDP toolkit includes a graphical representation of the PDP workflow, portions of which were shown in FIGS. 12-15, and which is used to guide users in executing the PDP workflow, and thereby generating the workflow of the process, which the client requires (e.g., the process to rollout a VPN, or the process to troubleshoot a network, etc.). The PDP toolkit also includes other documentation, such as assessment tools, such as GUI questionnaires, work files, help files, training documents, graphical aides, such as pictures, plans for initiating process development projects, blank engagement letters and other standard business documents, and ancillary documents as needed.

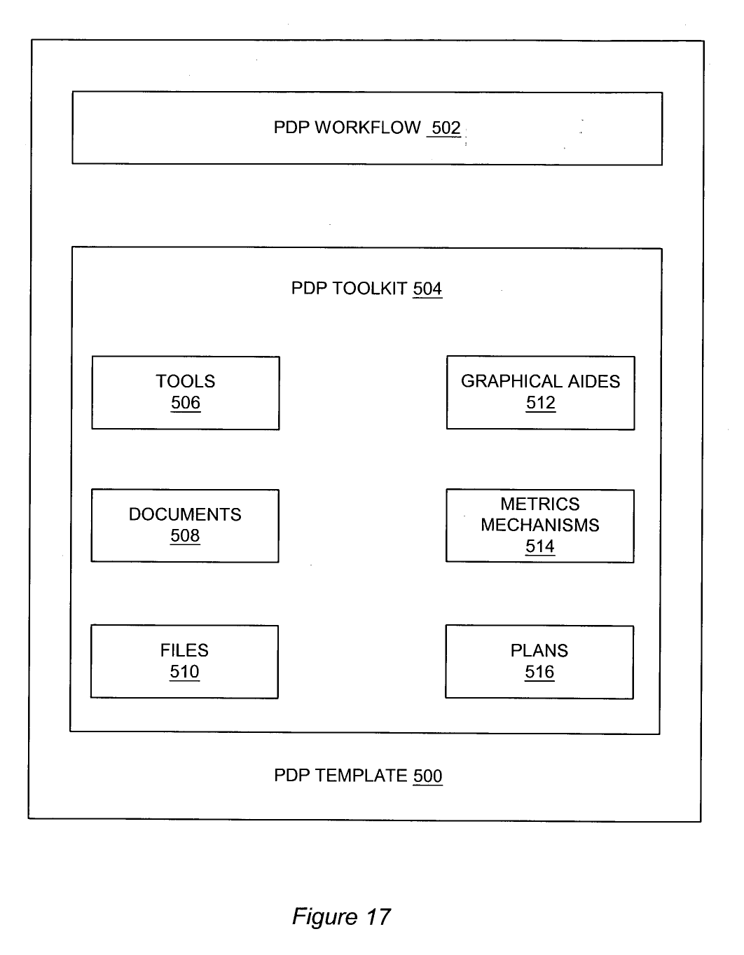

Thus, the PDP workflow and the PDP toolkit provide a template, a PDP template, for developing processes. FIG. 17 shows the PDP template (500), which includes the PDP workflow (502), and the PDP toolkit (504). The PDP toolkit (504) includes items (such as those named above), and represented generically as tools (506) (such as the GUI's shown in FIGS. 12-15 and used to guide users), documents (508), files (510), graphical aides (512), metrics mechanisms (514), and plans (516).

Returning to FIG. 12, the process workflow is generated by one or more users (typically a project team operating in a collaborative environment) executing the PDP workflow by using the PDP toolkit (Step 356). The PDP toolkit guides the users in the execution of the PDP workflow, thus creating the process workflow, which the client may use to rollout a VPN, troubleshoot a network, etc. The PDP toolkit and PDP workflow also provide mechanisms for modifying the workflow to create an improved workflow via mechanisms to capture lessons learned and best practices.

A process may be converted to a CEP with addition of collaborative enhancements. For example, a process for a particular enterprise may involve training new hires to perform a particular task. The process may involve a discussion of the task using a blackboard. A collaborative enhancement to the task may involve a streaming video feed over a network from a city hundreds of miles away so that a well-known expert (e.g., an SME) may be able to assist in training the new hires.

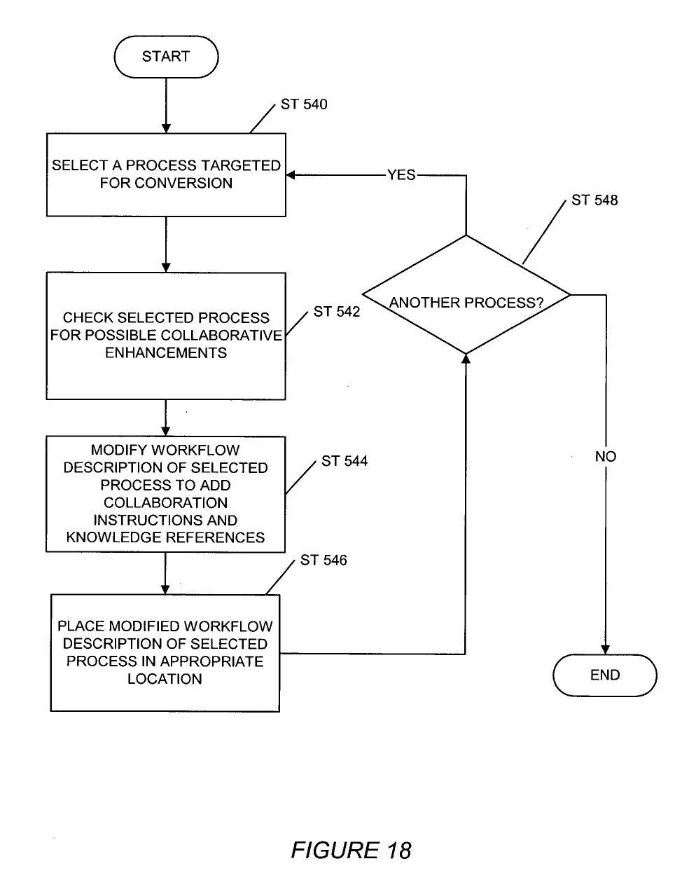

A Collaborative-Process Development Process (C-PDP) workflow converts processes into CEP's. The C-PDP workflow uses the PDP workflow and PDP toolkit as a core, and adds collaborative extensions that are collaboration instructions. The collaboration instructions are components of a C-PDP workflow. FIG. 18 shows a sequence of operations for the C-PDP workflow. First, a process is selected for conversion to a CEP (Step 540). Selecting a process for conversion to a CEP may occur, for example, after Step 378 as shown in FIG. 13, after processes have been sufficiently analyzed by executing the PDP workflow using the PDP toolkit.

Then, the selected process is checked for possible collaborative enhancements (Step 542). Checking the selected process for possible collaborative enhancements is accomplished in Steps 374-378 of the PDP workflow using the PDP toolkit. For example, a determination may be made as to whether the process may be divided into two or more parallel workflows. Also, a determination may be made as to whether the process may be improved with distant learning or online help. Other possible determinations include determining whether prior experience is available to apply to the process, and determining whether experts are available for real-time assistance as needed.

Next, a workflow of the selected process is modified to add collaboration instructions and knowledge references (Step 544). For example, referring to the previous example of the video-streamed expert assistance for training new hires, instructions for how to use software used to stream video may be packaged and presented to the training administrator.

Then, a modified workflow is of the selected process is stored in either the content management system (168 in FIG. 7) or in the project workspace (162 in FIG. 7), according to its usage environment (Step 546). A determination is then made as to whether another process is available for conversion (Step 548). If another process is available for conversion, another process is selected.

Once collaboration instructions have been added to the process workflow, Steps 380-386 from FIG. 13 are performed, and the output from the PDP workflow (386 in FIG. 13) is a CEP, instead of a process, because the modified workflow adds collaboration instructions.

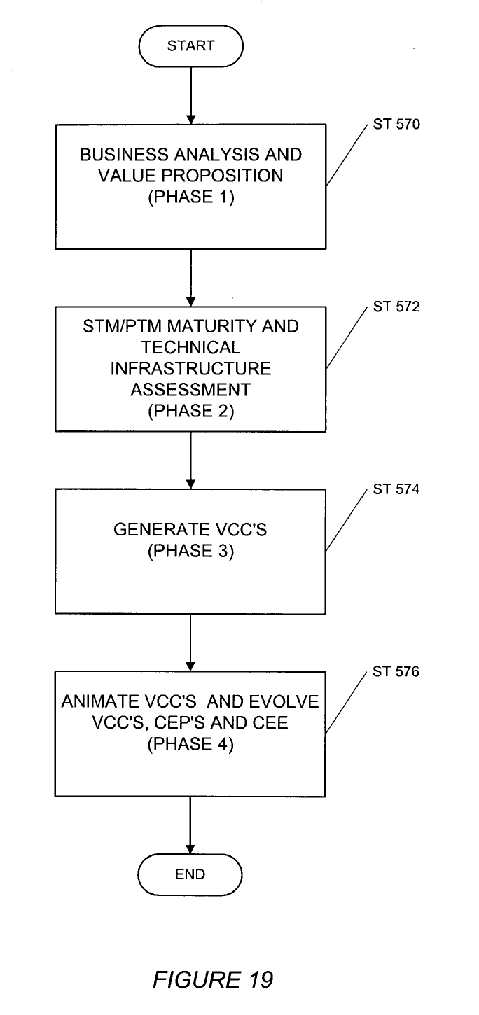

Conversion of processes to CEP's is performed when needed during the CEE methodology, which converts an enterprise to a CEE. FIG. 19 shows a flow diagram showing a sequence of four phases for converting a particular enterprise, such as an ISP, a law firm, or an accounting firm, etc., to a CEE. A first phase is generating a business analysis and value proposition (Step 570). A second phase is assessing STM maturity and technical infrastructure of the enterprise (Step 572). Steps 570-572 involve evaluating important aspects of the enterprise, using such techniques as CM techniques. A third phase is generating VCC's (Step 574). A fourth phase is animating the VCC's and operating and evolving the VCC's, the CEE, and the CEP's (Step 576). The flow diagram for converting an enterprise to a CEE is discussed in detail below.

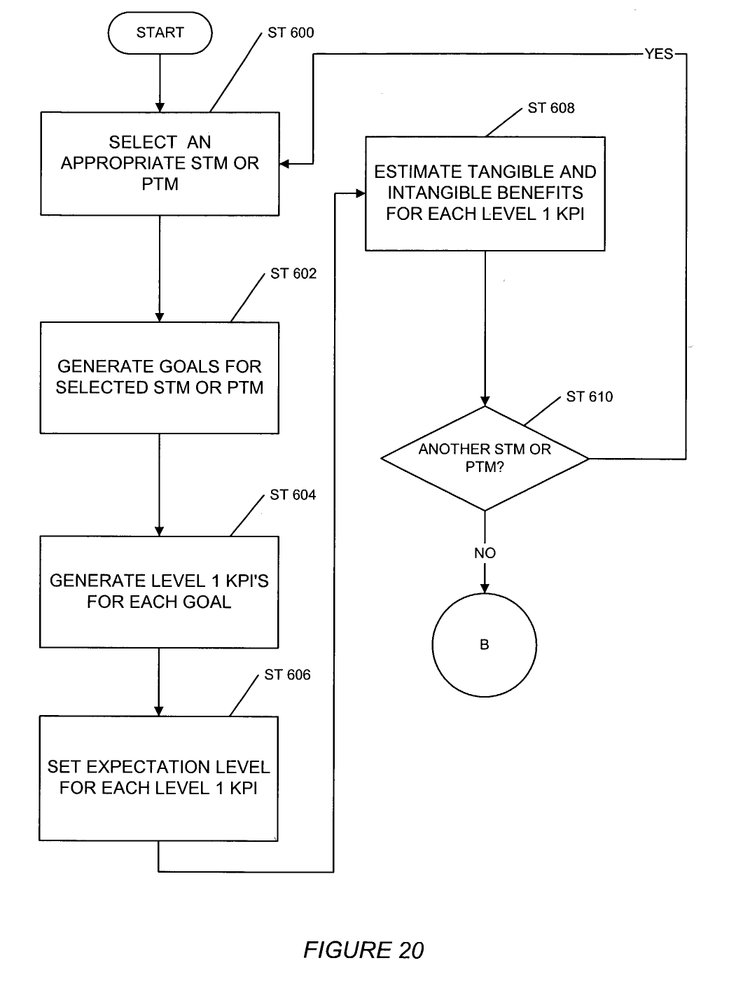

The first phase is implemented, in accordance with one or more embodiments of the invention, as shown in a flow diagram in FIG. 20. An appropriate STM or PTM is selected (Step 600). The appropriate STM or PTM is selected using an analysis of the enterprise (the ISP, accounting firm, VPN rollout team, etc.). The organizational structure, culture and business strategy of the enterprise is analyzed in order to determine which solutions, or products, or services upon which to focus, with respect to which STM's or PTM's present the best opportunities. Certain core technologies and methodologies are associated with the solutions or products brought into focus. Thus, such solutions or products and associated core technologies and methodologies are appropriate and, therefore, may be selected.

A list of goals for the selected STM or PTM is generated (Step 602). The list of goals is that which support business strategies of the enterprise. Then, a list of level 1 Key Performance Indicators (KPI's) is generated for each goal (Step 604). A KPI is a way to measure performance of a goal. For example, if the goal is better customer service, an exemplary KPI may be a measure of customer complaints. Then, for each KPI, an expectation level is set (Step 606). For example, a level of less than 100 customer complaints per month may be set.

An estimate of tangible and intangible benefits for successfully reaching each level 1 KPI is generated (Step 608). For example, an estimate of an additional $10,000 per month in additional revenue may be generated for the level of less than 100 customer complaints per month. A determination is then made as to whether another appropriate STM or PTM is available (Step 610). If another appropriate STM or PTM is available, another appropriate STM or PTM is selected (Step 660).

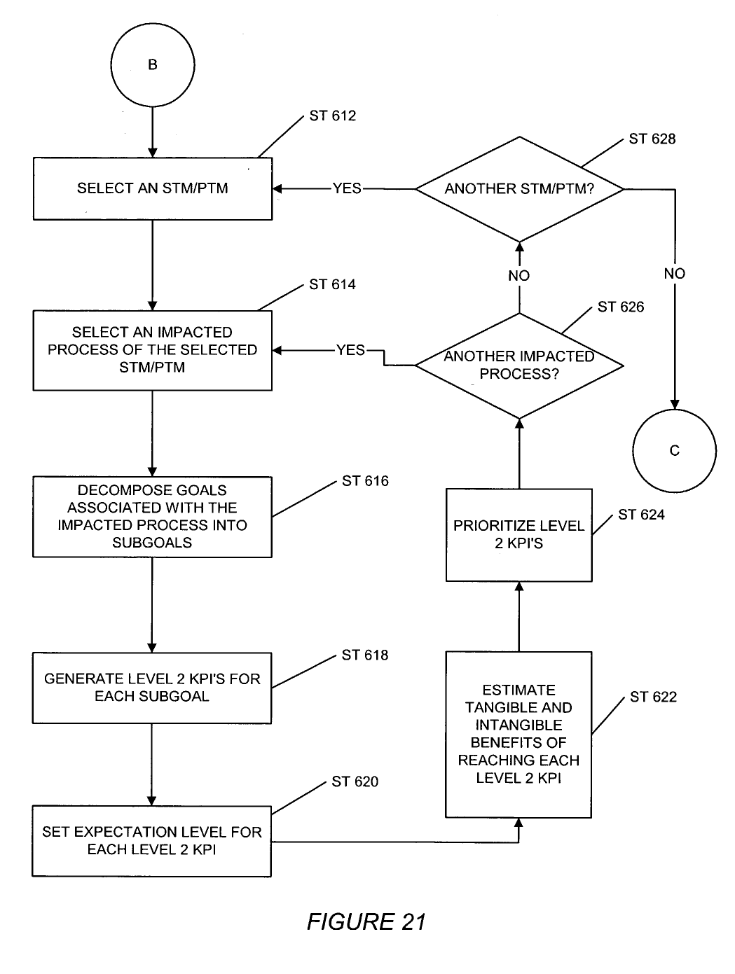

Otherwise, as shown in FIG. 21, an appropriate (where “appropriate” is as defined above) STM or PTM is selected (Step 612), and an impacted process of the selected STM or PTM is selected (Step 614). CM techniques and/or a result of a profile study may be used to analyze processes of the selected STM or PTM. The profile study may include a high level description of issues, and other important aspects of the processes of the selected PTM or PTM.

The selected impacted process is associated with one or more goals of the list of goal for the selected STM or PTM. Each goal associated with the selected impacted process is then decomposed into a list of subgoals (Step 616), and a one or more level 2 KPI's are generated for each subgoal of list of subgoals (Step 618). Then, an expectation level is set for each level 2 KPI (Step 620), and an estimate of tangible and intangible benefits for successfully reaching each level 1 KPI is generated (Step 622). Then, the level 2 KPI's are prioritized according to one or more predetermined criteria (Step 624).

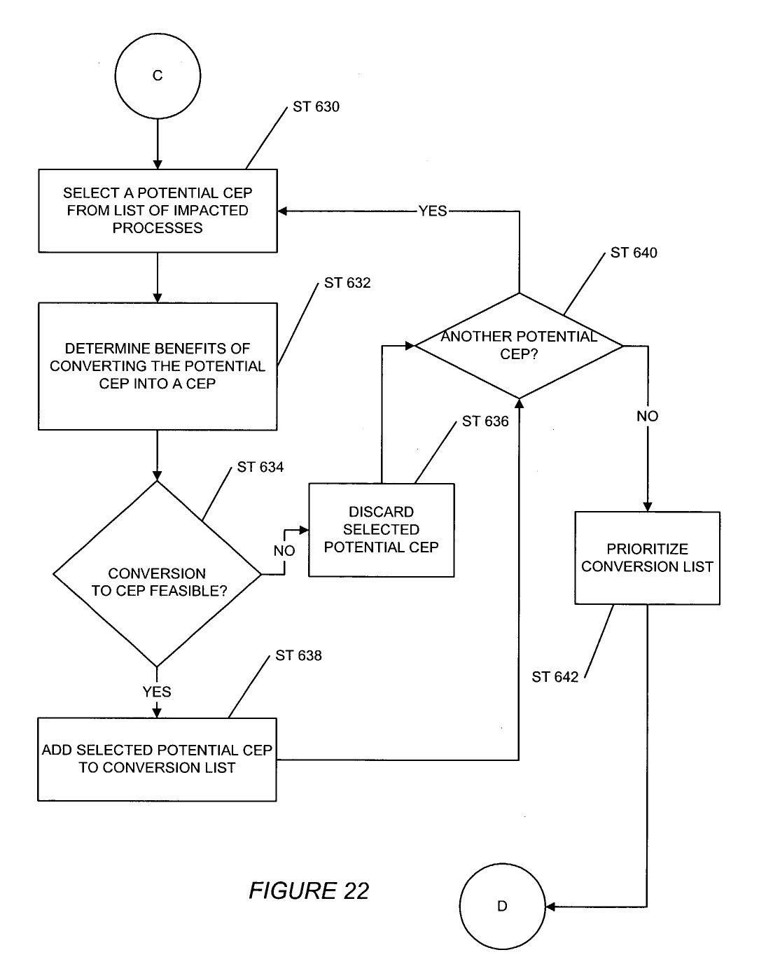

A determination is made as to whether another impacted process is available (Step 626), and, if so, another impacted process is selected (Step 624). Otherwise, a determination is made as to whether another appropriate STM or PTM is available (Step 628), and, if another appropriate STM or PTM is available, appropriate STM or PTM is selected (Step 612). Otherwise, as shown in FIG. 22, a potential CEP is selected from the list of impacted processes (Step 630). Potential CEP's are selected using the profile study for each impacted process, level 1 and level 2 KPI's, and documentation from the previous steps regarding expectation levels, tangible and intangible benefits, etc., may be used to select potential CEP's. Additionally, the C-PDP is used to identify what processes may potentially operate within the Synergy framework as CEP's. For example, processes that are not amenable to collaborative execution are typically not chosen as a potential CEP. Such processes are identified using the PDP toolkit with a user executing the PDP workflow.

Next, for the selected potential CEP, the benefits of converting the selected potential CEP into a CEP are determined (Step 632). Determining the benefits of converting the selected potential CEP into a CEP may be accomplished by verifying what level 2 KPI's would be satisfied by conversion, and to what degree the level 2 KPI's would be satisfied. Also, tangible and intangible benefits gained by conversion may be quantified.

A determination is made as to whether converting the selected potential. CEP to a CEP is feasible (Step 634). Determination of whether conversion to CEP is feasible, in accordance with one or more embodiment of the invention, is implemented using change management techniques, and accounts for conversion costs and estimated chances of conversion success.

If conversion is feasible, the selected potential CEP is added to a conversion list (for later conversion to a CEP) (Step 638), and a determination is made as to whether another potential CEP exists (Step 640). Otherwise, the selected potential CEP is discarded (Step 636), and Step 630 is performed. If no other potential CEP exists, the conversion list of potential CEP's is prioritized (Step 642). Prioritization is based on expected benefits and costs of conversion.

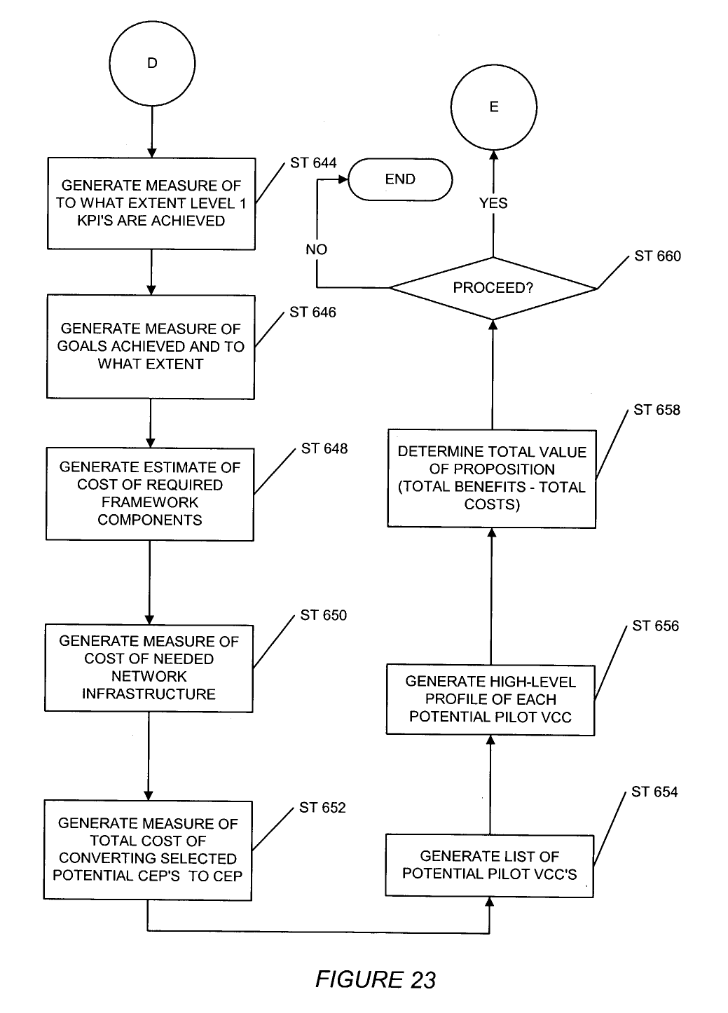

Then, as shown in FIG. 23, a measure of which level 1 KPI's are achieved and the extent of achievement is generated (Step 644). The measure may be determined from information gathered in Steps 612-624. Using the knowledge of the extent to which level 1 KPI's are achieved, a measurement of which goals are achieved, and to what extent, is generated (Step 646). Then, an estimate of a cost of installing required Synergy Technology framework components that do not already exist is generated (Step 648). Next, a measure of needed additional network infrastructure is generated (Step 650). Using information gathered in Steps 630-642, a cost of converting to CEP's the conversion list of potential CEP's is generated (Step 652).

Using techniques such as CM techniques, a list of potential pilot VCC's is generated (Step 654). Pilot VCC's are used to prove success in a short time frame. In accordance with one or more embodiments of the invention, a list of full-fledged VCC's may be generated in Step 654. Selection of pilot VCC's are based on estimated the duration of a pilot, the chances of the pilot being successful, and the value of the pilot to the enterprise. Critical to the success of pilot VCC's is the availability of personnel within the enterprise to lead such change. CM techniques may be used to identify people and place them in appropriate pilot VCC's.

Next, a high-level profile is generated for each potential pilot VCC (Step 656). The high-level profile of a pilot VCC includes listing of CEP's associated with the VCC and what people are involved with the VCC. The high-level profile considers a number of relevant criteria, such as determining what people belong to a pilot VCC, and which people are knowledge gatekeepers of the pilot VCC. Also considered as part of the high-level profile is considering what particular STM or PTM the pilot VCC supports and what knowledge a pilot VCC should capture and share.

Also considered as part of the high-level profile are criteria such as where relevant knowledge is located, and whether the knowledge is explicit or tacit. Knowledge shared offline into a knowledge base is explicit; p2I collaboration components share knowledge explicitly by capturing, cataloguing, and making available the knowledge in deliberately constructed mechanisms, e.g., a static web page telling a user how to perform a task. Knowledge shared in real-time is implicit knowledge; p2I collaboration components share knowledge implicitly or tacitly. The knowledge is stored in individual's brains. For example, referring to FIG. 10, the e-Feedback hyperlink (290 in FIG. 10) represents a p2p collaboration component that shares knowledge tacitly.

Knowledge is also stored within people. Often, much of the critical knowledge must be obtained from the employees. Again, CM techniques may be used to identify those who not only have the knowledge, but who are willing to share it.

Next, a total value of proposition is generated (Step 658). The total value of proposition is total benefits minus total costs. A determination is made as to whether to proceed with creation of the CEE (Step 660). The determination as to whether to proceed with creation of the CEE is based on the total value of proposition.

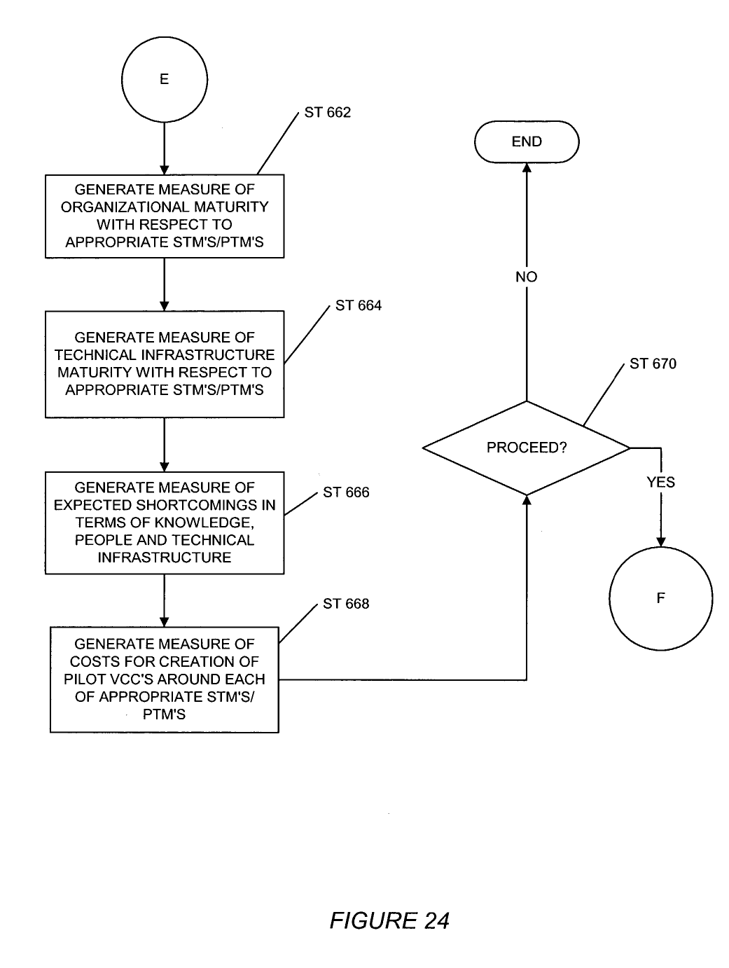

If total value of proposition is not suitable, and creation of the CEE does not proceed, the flow diagram terminates. Otherwise, as shown in FIG. 24, a measure of organizational maturity of the enterprise with respect to the selected, appropriate STM's or PTM's is generated (Step 662). Certain enterprises may not be mature enough to handle CEP's in connection with particular STM's or PTM's with respect to corporate culture.

Next, a measure of technical infrastructure maturity of the enterprise with respect to the selected, appropriate STM's or PTM's is generated (Step 664). Then, a measure of expected personnel, skills, and technical infrastructure shortcomings with respect to the selected, appropriate STM's or PTM's is generated (Step 666). Next, using information gathered in Steps 644-658, a measure of costs for creation of pilot VCC's around the selected, appropriate VCC's is generated (Step 668).

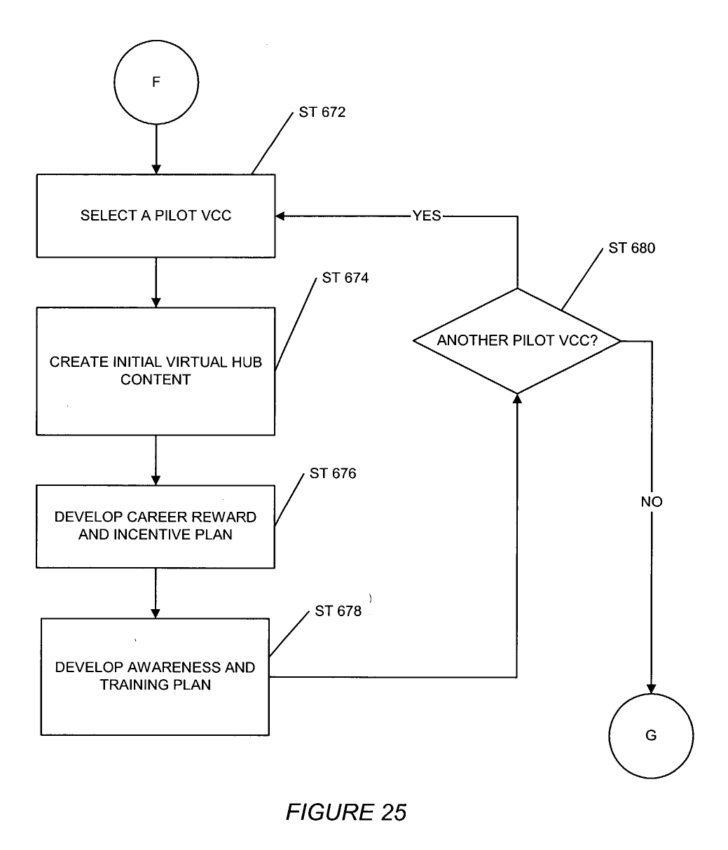

A determination is then made as to whether to proceed (Step 670). The determination is then made as to whether to proceed is based on a result of the measure of costs generated in Step 668. If a decision is made not to proceed, the flowchart terminates; otherwise, as shown in FIG. 25, a potential pilot VCC is selected (Step 672). The selected potential pilot VCC is selected from the list of potential pilot VCC's. For the selected VCC, initial virtual hub content is generated (Step 674). Initial virtual hub content may include CEP's, which may be re-engineered using the C-PDP. Any other necessary knowledge item may be included as initial VCC content. For example, information for the virtual hub may come primarily from those employees who have already been identified as having knowledge critical for change, and who are willing to share it. These people knowledge providers are used to populate the pilot VCC, and their knowledge is organized according to a taxonomy, and is made available via the virtual hub and the Synergy technology framework for the benefit of knowledge consumers.

Next, using Change Management (CM) techniques, a career reward and incentive plan is generated (Step 676). The career reward and incentive plan is designed to support and motivate individuals involved with different roles in the life of the selected VCC. Next, using Change Management (CM) techniques, an awareness and training plan is developed (Step 678). The awareness and training plan is designed with the enterprise's training and Human Resources (HR) personnel in order to fit with the pilot VCC in terms of a geographical and logistical profile of the pilot VCC.

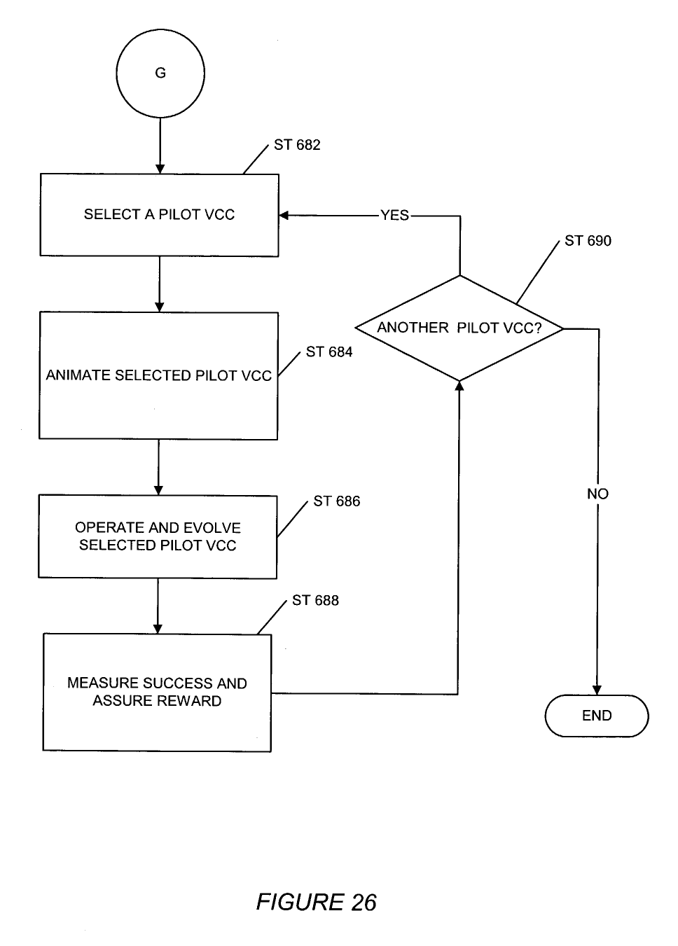

A determination is made as to whether another pilot VCC is available (Step 680). If another pilot VCC is available, another pilot VCC is selected. Otherwise, as shown in FIG. 26, a pilot VCC is selected from the list of VCC's (Step 682), and the selected VCC is animated (Step 684). Animation of the selected VCC may proceed when initial, minimum set of STM knowledge exists so that collaboration and knowledge sharing may proceed. Animation, in accordance with one or more embodiments of the invention, may include installation and activation of appropriate Synergy technology framework and network infrastructure components. Also, people are added to the Synergy people framework during Step 684. For example, SME's and trainers may be assigned as needed.

Once the selected pilot VCC is animated, the selected pilot VCC is operated and evolved (Step 686). The Synergy people framework verifies and supports the correct execution of a set of CEP's that determine how the selected pilot VCC should operate in order to achieve desired results. Operation of the selected VCC includes intellectual capital sharing and re-use through collaborative knowledge exchanges. For example, a project leader may participate in the execution of many CEP's, which experience garners valuable knowledge that may be shared with other members of the leader's pilot VCC, and with members of other pilot VCC's. Once the project leader has made the newfound knowledge available via a virtual hub and the Synergy technology framework, the knowledge may be accessed by others.

For example, a member of the pilot VCC may use the portal to sign on to an external web application, e.g., a solutions virtual hub implemented as a web page concerning a Smart Badge, using a smart card. The user may sign-on a single time (i.e., transparently) to the solutions virtual hub, and collaborate with other members of the pilot VCC using a collaboration component. For example, the user may be an employee with new information about a Lesson Learned or a Best Practice related to a particular CEP. Therefore, the user may engage in p2p collaboration by clicking on the e-Feedback hyperlink of the Smart Badge web page. The user then fills out a feedback form, which is sent via the Synergy technology framework to an SME, a member of the Synergy people framework with knowledge of the Smart Badge.

An SME may then read the feedback form sent by the user and modify the CEP workflow. Thus, CEP's, VCC's, and the CEE are evolved in real-time by collaboration between members of a VCC via a virtual hub using the Synergy technology framework. Another technique for evolving the CEE is to publicize success stories, where a particular VCC, for example, has made good progress towards reaching CEE goals through use of collaboration techniques.

Next, success is measured and reward is assured (Step 688). CM techniques may be used to measure and reward success. One or more members of the Synergy people framework supporting the pilot VCC are responsible for verifying that the CEP's are executed properly by the members of the Synergy people framework, that the CEP's achieve expected goals, and that those members of the VCC that contribute actively to the life of the community are consistently rewarded. Next, a determination is made as to whether another pilot VCC is available (Step 690), and if so, another pilot VCC is selected (Step 682). After a predetermined period of time, pilot VCC's are determined to be full-fledged VCC's.

Advantages of various embodiments of the present invention may include one or more of the following. In one or more embodiments, the core products or services that are key to the business' success are targeted for collaboration. The enterprise's technologies, methodologies, and key business processes are designed to operate in a collaborative environment. Key collaborative-enabling Information Technology (IT) technologies are in place and implemented within a larger enterprise collaborative environment. And, finally, many of these elements are developed in connection with high-level business strategy and operational plans.

Embodiments of the present invention are applicable to medium to large enterprises that require its members to use collaboration and knowledge sharing techniques closely aligned with its business strategy. These include the upstream operations of energy and energy services companies, the engineering and construction industry, consulting and other service enterprises involved in project-oriented business, and any enterprise with a need to improve its operational excellence, customer intimacy, or product-to-market excellence. The entire suite of the invention's components, including the Synergy framework and method of constructing the Synergy framework, is applicable. Selected sub-components of the Synergy framework and method of constructing the Synergy framework are also usable standalone

Embodiments of the present invention are also applicable for more procedurally oriented businesses. Procedures exist in all enterprises, but are particularly important in service provider, healthcare, insurance, and financial enterprises, and in most information processing businesses. In these markets, the method of constructing the Synergy framework, if applied properly, will transform any suitably motivated enterprise into one with a more mature and effective collaboration culture. Other advantages will be apparent from the above description and attached claims.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of enabling an enterprise for collaboration, comprising:
evaluating the enterprise for collaborative potential;
selecting a first process of the enterprise using a first result of the evaluation of the enterprise;
generating a first Collaboration-Enabled Process (CEP) using the first process if the first process satisfies a first criteria;
generating a first Virtual Collaborative Community (VCC) using a first plurality of employees of the enterprise; and
executing the first CEP using the VCC, wherein a first member and a second member of the first plurality of employees collaborate in executing the first CEP by communicating via a first virtual hub.

2. The method of claim 1, further comprising:
obtaining content for the first VCC using a second result of the evaluation.
organizing the content and making the content available to entities outside the first VCC via a technology framework and the first virtual hub.

3. The method of claim 2, further comprising:
selecting a second process of the enterprise using a second result of the evaluation;
generating a second CEP using the second process if the second process satisfies a second criteria;
generating a second VCC using a second plurality of employees of the enterprise; and
executing the second CEP using the second plurality of employees, wherein a third member and a fourth member of the second plurality of employees collaborate in executing the second CEP by communicating via a second virtual hub.

4. The method of claim 3, further comprising:
obtaining knowledge learned from the execution of the first CEP;
adding the knowledge to the content and using the knowledge to modify the first CEP;
obtaining the content by the third member of the second plurality of employees via the technology framework and the first virtual hub; and
using the content to modify the second CEP.

5. The method of claim 4, wherein the technology framework is secured using a Public Key Infrastructure (PKI).

6. The method of claim 1, further comprising:
generating a reward system, wherein the reward system rewards a member of the first plurality of employees for collaborative behavior.

7. The method of claim 1, wherein the first VCC is a pilot VCC.

8. The method of claim 1, wherein the first process is selected if the first result of the evaluation indicates that converting the first process to the first CEP satisfactorily furthers a goal of the enterprise.

9. The method of claim 8, wherein the first process is selected if the first result further indicates that converting the first process to the first CEP represents a satisfactory cost-benefit ratio for the enterprise.

10. The method of claim 1, wherein the first process satisfies the first criteria if the first process is suitable for collaboration enabling.

11. The method of claim 10, wherein a Collaborative-Process Development Process (C-PDP) workflow is executed to determine whether the first process is suitable for collaboration enabling, wherein a PDP toolkit is used by a user to execute the C-PDP workflow.

12. A method of enabling an enterprise for collaboration, comprising:
evaluating the enterprise for collaborative potential;
selecting a first process of the enterprise using a first result of the evaluation of the enterprise;
generating a first Collaboration-Enabled Process (CEP) using the first process if the first process satisfies a first criteria;
generating a first Virtual Collaborative Community (VCC) using a first plurality of employees of the enterprise;
executing the first CEP using the VCC, wherein a first member and a second member of the first plurality of employees collaborate in executing the first CEP by communicating via a first virtual hub;
obtaining content for the first VCC using a second result of the evaluation;
organizing the content and making the content available to entities outside the first VCC via a technology framework and the first virtual hub;
selecting a second process of the enterprise using a second result of the evaluation;
generating a second CEP using the second process if the second process satisfies a second criteria;
generating a second VCC using a second plurality of employees of the enterprise;
executing the second CEP using the second plurality of employees, wherein a third member and a fourth member of the second plurality of employees collaborate in executing the second CEP by communicating via a second virtual hub;
obtaining knowledge learned from the execution of the first CEP;
adding the knowledge to the content and using the knowledge to modify the first CEP;
obtaining the content by the third member of the second plurality of employees via the technology framework and the first virtual hub;
using the content to modify the second CEP; and
generating a reward system, wherein the reward system rewards a member of the first plurality of employees for collaborative behavior.

13. A Collaboration-Enabled Enterprise (CEE), comprising:
a first Collaboration-Enabled Process (CEP), supporting an output of the CEE, collaboratively executed by a plurality of members of a first Virtual Collaborative Community (VCC) via a virtual hub;
a Synergy people framework supporting the virtual hub, configured to facilitate collaboration between the plurality of members of the first VCC; and
a second VCC, configured to obtain content of the first VCC via a Synergy technology framework and the virtual hub and modify a second CEP using the content.

14. The CEE of claim 13, the Synergy technology framework comprising:
a network infrastructure configured to handle digital traffic of the CEE;
a set of applications within which the CEE operates;

15. The CEE of claim 14, the Synergy technology framework further comprising:
a security management system configured to secure a communication sent via the Synergy technology framework using a Public Key Infrastructure (PKI);
a content management system for managing the content;
a portal through which a member of the plurality of members of the first VCC accesses the Synergy technology framework to send the communication; and
a directory server authenticating and authorizing the communication.

16. The CEE of claim 15, wherein the content is accessible via the virtual hub and is organized using a taxonomy.

17. The CEE of claim 15, wherein the communication is encrypted.

18. The CEE of claim 13, wherein the virtual hub is configured to support an exchange of knowledge between a first member and a second member of the plurality of members.

19. The CEE of claim 18, wherein the Synergy people framework uses the virtual hub to evolve the first CEP by receiving feedback from the first member of the plurality of members.

20. The CEE of claim 19, wherein the first member of the plurality of members is a knowledge provider.

21. The CEE of claim 19, wherein the second member of the plurality of members is a knowledge consumer.

22. The CEE of claim 13, wherein the first CEP is generated by modifying a workflow of a process by a user executing a Collaborative Process Development Process (CPDP) workflow.

23. The CEE of claim 22, wherein the execution of the C-PDP workflow by the user is guided by a PDP toolkit.

24. The CEE of claim 22, wherein the process is selected for conversion to the first CEP using a first result of an evaluation of an enterprise and a second result of an evaluation of the process.

25. The CEE of claim 24, wherein the process is selected for conversion to the first CEP if the first result of the evaluation of the enterprise indicates that converting the process to the first CEP satisfactorily furthers a goal of the enterprise.

26. The CEE of claim 24, wherein the process is selected for conversion to the first CEP if the first result of the evaluation of the enterprise indicates that converting the process to the first CEP represents a satisfactory cost-benefit ratio for the enterprise.

27. The CEE of claim 24, wherein the process is selected for conversion to the first CEP if the second result of the evaluation of the process indicated that the process is suitable for collaboration enabling.

28. A method of converting a process to a Collaboration-Enabled Process (CEP) using a Collaborative-Process Development Process (C-PDP), comprising:
conducting a first analysis of the workflow of the process;
conducting a second analysis of available resources for executing the process;
selecting a collaborative enhancement for the process; and
generating a modified workflow of the process by adding collaboration instructions to the workflow.

29. The method of claim 28, further comprising:
storing the modified workflow according to a usage environment of the CEP.

30. The method of claim 28, generating the modified workflow further comprising adding knowledge references to the workflow.

31. A method of converting a process to a Collaboration-Enabled Process (CEP) using a Collaborative-Process Development Process (C-PDP), comprising:
conducting a first analysis of the workflow of the process;
conducting a second analysis of available resources for executing the process;
selecting a collaborative enhancement for the process;
generating a modified workflow of the process by adding collaboration instructions to the workflow; and
storing the modified workflow according to a usage environment of the CEP.

32. A apparatus for enabling an enterprise for collaboration, comprising:
means for evaluating the enterprise for collaborative potential;
means for selecting a first process of the enterprise using a first result of the evaluation of the enterprise;
means for generating a first Collaboration-Enabled Process (CEP) using the first process if the first process satisfies a first criteria;
means for generating a first Virtual Collaborative Community (VCC) using a first plurality of employees of the enterprise; and
means for executing the first CEP using the VCC, wherein a first member and a second member of the first plurality of employees collaborate in executing the first CEP by communicating via a first virtual hub.

33. An apparatus for converting a process to a Collaboration-Enabled Process (CEP) means for using a Collaborative-Process Development Process (C-PDP), comprising:
means for conducting a first analysis of the workflow of the process;
means for conducting a second analysis of available resources for executing the process;
means for selecting a collaborative enhancement for the process; and
means for generating a modified workflow of the process by adding collaboration instructions to the workflow.
